(19) United States
(12) Patent Application Publication
(10) Pub. No.: US 2013/0312324 A1
(43) Pub. Date: Nov. 28, 2013

(54) COLLAPSIBLE AND/OR ERECTABLE FLORAL CONTAINERS AND METHODS OF PRODUCTION AND USE THEREOF

(71) Applicant: Wanda M. Weder and William F. Straeter, not individually but solely as Trustees of The Family, Highland, IL (US)

(72) Inventor: Donald E. Weder, Highland, IL (US)

(73) Assignees: Trust U/T/A dated 12/8/1995, Highland, IL (US); Wanda M. Weder and William F. Straeter, not individually but solely as Trustees of The Family

(21) Appl. No.: 13/958,759

(22) Filed: Aug. 5, 2013

Related U.S. Application Data
(63) Continuation of application No. 13/613,879, filed on Sep. 13, 2012, now abandoned.
Application No. 13/613,879 is a continuation of application No. 13/445,293, filed on Apr. 12, 2012, now abandoned.
Application No. 13/445,293 is a continuation of application No. 13/070,626, filed on Mar. 24, 2011, now abandoned.
Application No. 13/070,626 is a continuation of application No. 12/841,509, filed on Jul. 22, 2010, now abandoned.
Application No. 12/841,509 is a continuation of application No. 12/470,066, filed on May 21, 2009, now abandoned.
Application No. 12/470,066 is a continuation of application No. 11/177,839, filed on Jul. 8, 2005, now abandoned.
Application No. 11/177,839 is a division of application No. 11/103,405, filed on Apr. 11, 2005, now abandoned.
(60) Provisional application No. 60/663,640, filed on Mar. 21, 2005.

(51) Int. Cl. A01G 9/02

(52) U.S. Cl. CPC A01G 9/026
USPC 47/66.7

(57) ABSTRACT

A collapsible and/or erectable shape-sustaining flower pot and/or plant cover having a substantially erect condition and substantially collapsed condition is disclosed. The collapsible and/or erectable shape-sustaining flower pot and/or plant cover may be provided with at least one condition modifying element to facilitate erecting and/or collapsing the flower pot and/or plant cover.

### CROSS-REFERENCE TO RELATED APPLICATIONS/INCORPORATION BY REFERENCE STATEMENT

The present application is a continuation of U.S. Ser. No. 13/613,879, filed Sep. 13, 2012, now abandoned; which is a continuation of U.S. Ser. No. 13/445,293, filed Apr. 12, 2012, now abandoned; which is a continuation of U.S. Ser. No. 13/070,626, filed Mar. 24, 2011, now abandoned; which is a continuation of U.S. Ser. No. 12/841,509, filed Jul. 22, 2010, now abandoned; which is a continuation of U.S. Ser. No. 12/470,066, filed May 21, 2009, now abandoned; which is a continuation of U.S. Ser. No. 11/177,839, filed Jul. 8, 2005, now abandoned; which is a divisional of U.S. Ser. No. 11/103,405, filed Apr. 11, 2005, now abandoned; which claims benefit under 35 U.S.C. 119(e) of Provisional Application Ser. No. 60/663,640, filed Mar. 21, 2005. All of the above-referenced applications are hereby expressly incorporated herein by reference in their entirety.

### STATEMENT REGARDING FEDERALLY SPONSORED RESEARCH OR DEVELOPMENT

Not applicable.

### BACKGROUND

Flowers and other plants have long been grown and displayed in pots, commonly referred to as “flower pots”. Flower pots are generally constructed of natural, earthen material, such as clay, which is in turn glazed and fired to produce a hardened, non-flexible ceramic structure. Flower pots have also been constructed of plastic materials which are colored or painted to have the appearance of an earthen material.

While clay or ceramic flower pots are both aesthetically pleasing and effectively serve the purpose of containing plant material and a growing medium, inefficiencies are nevertheless experienced in shipping and storing such containers due to the their bulkiness and susceptibility to breakage. More specifically, ceramic flower pots are rigid but at the same time are quite fragile. Because of their rigidity, a large volume of space is required for both shipping and storing ceramic flower pots which results in high shipping and storage costs. Their inflexibility further results in increased losses due to breakage.

To prevent breakage large amounts of dunnage material is required, which also results in higher costs. While breakage is not so much a problem with plastic flower pots, plastic flower pots nevertheless require a significant amount of space for storage and shipment.

To this end, a need exists for a flower pot, flower pot cover or vase that can be shipped and stored in a substantially flattened condition and readily erected into a container that can hold a growing medium and plant material and that has a ceramic appearance. In addition, a need also exists in the art for a flower pot, vase or flower pot cover that is produced in an erected condition and can be collapsed for transportation and/or storage. It is to such a presently disclosed and claimed inventive concept(s) that the present application is directed.

### BRIEF DESCRIPTION OF THE SEVERAL VIEWS OF THE DRAWINGS

FIG. 1 is a perspective view of a collapsible and/or erectable container constructed in accordance with the presently disclosed and claimed inventive concept(s) shown disposed about a flower pot.

FIG. 2 is a side elevational view of the collapsible and/or erectable container of FIG. 1 shown in a collapsed condition.

FIG. 3 is an end elevational view of the collapsible and/or erectable container of FIG. 1 shown in the collapsed condition.

FIG. 4 is a perspective view of a flexible liner in an expanded condition.

FIG. 5 is a plan view of a portion of another embodiment of a collapsible and/or erectable container constructed in accordance with the presently disclosed and claimed inventive concept(s) showing the hinged connection of two rigid segments of the collapsible and/or erectable container.

FIG. 6 is a top plan view of a collapsible and/or erectable container constructed in accordance with the presently disclosed and claimed inventive concept(s) shown in a collapsed condition.

FIG. 7 is a top plan view of the collapsible and/or erectable container of FIG. 6 shown in an expanded condition.

FIG. 8 is a top plan view of another embodiment of a collapsible and/or erectable container constructed in accordance with the presently disclosed and claimed inventive concept(s) shown in an expanded condition.

FIG. 9 is a top plain view of another embodiment of a collapsible and/or erectable container constructed in accordance with the presently disclosed and claimed inventive concept(s) shown in a collapsed condition.

FIG. 10 is a plan view of a portion of another embodiment of a collapsible and/or erectable container constructed in accordance with the presently disclosed and claimed inventive concept(s) showing the hinged connection of two rigid segments of the collapsible and/or erectable container with the collapsible and/or erectable container in a collapsed condition.

FIG. 11 is a top plan view of a portion of the collapsible and/or erectable container of FIG. 10 shown in an expanded position.

FIG. 12 is a plan view of a portion of two rigid segments constructed in accordance with the presently disclosed and claimed inventive concept(s).

FIG. 13 is a plan view of the two segments of FIG. 12 shown connected together.

FIG. 14 is an elevational view of another embodiment of a collapsible and/or erectable container constructed in accordance with the presently disclosed and claimed inventive concept(s).

FIG. 15 is a sectional view of another embodiment of a collapsible and/or erectable container constructed in accordance with the presently disclosed and claimed inventive concept(s).

FIGS. 16A-16E are plan views of various shapes of rigid segments used in constructing collapsible and/or erectable containers in accordance with the presently disclosed and claimed inventive concept(s).

FIG. 17 is a sectional view of another embodiment of a collapsible and/or erectable container constructed in accordance with the presently disclosed and claimed inventive concept(s).

FIG. 18 is a sectional view of another embodiment of a collapsible and/or erectable container constructed in accordance with the presently disclosed and claimed inventive concept(s).

FIG. 19 is a sectional view of another embodiment of a collapsible and/or erectable container constructed in accordance with the presently disclosed and claimed inventive concept(s).

FIG. 20 is a sectional view of another embodiment of a collapsible and/or erectable container constructed in accordance with the presently disclosed and claimed inventive concept(s).

FIG. 21 is a perspective view of another embodiment of a collapsible and/or erectable container constructed in accordance with the presently disclosed and claimed inventive concept(s).

FIG. 22 is a sectional view of another embodiment of a collapsible and/or erectable container constructed in accordance with the presently disclosed and claimed inventive concept(s).

FIG. 23 is a side view of another embodiment of a collapsible and/or erectable container constructed in accordance with the presently disclosed and claimed inventive concept(s).

FIG. 24 is a top plan view of the collapsible and/or erectable container of FIG. 23.

FIG. 25 is a perspective view of the collapsible and/or erectable container of FIGS. 23 and 24 in a substantially collapsed condition.

FIG. 26 is a side view of another embodiment of a collapsible and/or erectable container constructed in accordance with the presently disclosed and claimed inventive concept(s).

FIG. 27 is a top plan view of the collapsible and/or erectable container of FIG. 26.

FIGS. 28A and 28B are perspective views of the collapsible and/or erectable container of FIGS. 26 and 27 in two different substantially collapsed conditions.

FIG. 29 is a side view of another embodiment of a collapsible and/or erectable container constructed in accordance with the presently disclosed and claimed inventive concept(s).

FIG. 30 is a top plan view of the collapsible and/or erectable container of FIG. 29.

FIG. 31 is a perspective view of the collapsible and/or erectable container of FIGS. 29 and 30 in a substantially collapsed condition.

FIG. 32 is a side view of another embodiment of a collapsible and/or erectable container constructed in accordance with the presently disclosed and claimed inventive concept(s).

FIG. 33 is a top plan view of the collapsible and/or erectable container of FIG. 32.

FIGS. 34A and 34B are perspective views of the collapsible and/or erectable container of FIGS. 32 and 33 in two different substantially collapsed conditions.

FIG. 35 is a side view of another embodiment of a collapsible and/or erectable container constructed in accordance with the presently disclosed and claimed inventive concept(s).

FIG. 36 is a top plan view of the collapsible and/or erectable container of FIG. 35.

FIG. 37 is a perspective view of the collapsible and/or erectable container of FIGS. 35 and 36 in a substantially collapsed position.

FIG. 38 is a cross-sectional view of another embodiment of a collapsible and/or erectable container constructed in accordance with the presently disclosed and claimed inventive concept(s).

FIG. 39 is a cross-sectional view of the collapsible and/or erectable container of FIG. 38 in a substantially collapsed position.

FIG. 40 is a perspective view of another embodiment of a collapsible and/or erectable container constructed in accordance with the presently disclosed and claimed inventive concept(s), wherein the collapsible and/or erectable container is illustrated as having a base portion and a skirt portion.

FIG. 41 is a perspective view of the collapsible and/or erectable container of FIG. 40 wherein the base portion of the collapsible and/or erectable container is in a substantially collapsed position.

FIG. 42 is a cross-sectional view of the collapsible and/or erectable container of FIG. 41 wherein the base portion is in a substantially collapsed position.

FIG. 43 is a perspective view of the collapsible and/or erectable container of FIGS. 40-42 wherein the base and skirt portions of the collapsible and/or erectable container are both in substantially collapsed positions.

FIG. 44 is a perspective view of another embodiment of a collapsible and/or erectable container constructed in accordance with the presently disclosed and claimed inventive concept(s).

FIG. 45 is a cross-sectional view of the collapsible and/or erectable container of FIG. 44 in a substantially collapsed condition.

FIG. 46 is a cross-sectional view of the collapsible and/or erectable container of FIG. 44 is an alternative substantially collapsed condition.

FIG. 47 is a perspective view of another embodiment of a collapsible and/or erectable container constructed in accordance with the presently disclosed and claimed inventive concept(s).

FIG. 48 is a perspective view of the collapsible and/or erectable container of FIG. 47 in a substantially collapsed condition.

FIG. 49 is a perspective view of a collapsible and/or erectable container constructed in accordance with the presently disclosed and claimed inventive concept(s) and comprising a base portion and an upper portion.

FIG. 50 is a perspective view of a collapsible and/or erectable container constructed in accordance with the presently disclosed and claimed inventive concept(s) and comprising a base portion, a skirt portion and an upper portion.

FIG. 51 is a perspective view of the collapsible and/or erectable container of FIG. 50 wherein the upper portion has been removed.

FIG. 52 is a cross-sectional view of another embodiment of a collapsible and/or erectable container constructed in accordance with the presently disclosed and claimed inventive concept(s).

FIG. 53 is a cross-sectional view of the collapsible and/or erectable container of FIG. 52 in a substantially collapsed condition.

FIG. 54 is a perspective view of another embodiment of a collapsible and/or erectable container constructed in accordance with the presently disclosed and claimed inventive concept(s).

FIG. 55 is a bottom plan view of the collapsible and/or erectable container of FIG. 54.

FIG. 56 is a perspective view of the collapsible and/or erectable container of FIGS. 54 and 55 in a substantially collapsed condition.

FIG. 57 is a cross-sectional view of another embodiment of a collapsible and/or erectable container constructed in accordance with the presently disclosed and claimed inventive concept(s).

FIG. 58 is a cross-sectional view of the collapsible and/or erectable container of FIG. 57 in a substantially collapsed condition.

FIG. 59 is a cross-sectional view of another embodiment of a collapsible and/or erectable container constructed in accordance with the presently disclosed and claimed inventive concept(s).

FIG. 60 is a cross-sectional view of the collapsible and/or erectable container of FIG. 59 in a substantially collapsed condition.

FIG. 61 is a perspective view of another embodiment of a collapsible and/or erectable container constructed in accordance with the presently disclosed and claimed inventive concept(s).

### DETAILED DESCRIPTION

Before explaining at least one embodiment of the presently disclosed and claimed inventive concept(s) in detail, it is to be understood that the presently disclosed and claimed inventive concept(s) is not limited in its application to the details of construction and the arrangement of the components or steps or methodologies set forth in the following description or illustrated in the drawings. The presently disclosed and claimed inventive concept(s) is capable of other embodiments or of being practiced or carried out in various ways. Also, it is to be understood that the phraseology and terminology employed herein is for the purpose of description and should not be regarded as limiting.

Unless otherwise defined herein, technical terms used in connection with the presently disclosed and claimed inventive concept(s) shall have the meanings that are commonly understood by those of ordinary skill in the art. Further, unless otherwise required by context, singular terms shall include pluralities and plural terms shall include the singular.

All patents, published patent applications, and non-patent publications mentioned in the specification are indicative of the level of skill of those skilled in the art to which this presently disclosed and claimed inventive concept(s) pertains. All patents, published patent applications, and non-patent publications referenced in any portion of this application are herein expressly incorporated by reference in their entirety to the same extent as if each individual patent or publication was specifically and individually indicated to be incorporated by reference.

All of the articles and/or methods disclosed and claimed herein can be made and executed without undue experimentation in light of the present disclosure. While the articles and methods of the presently disclosed and claimed inventive concept(s) have been described in terms of particular embodiments, it will be apparent to those of skill in the art that variations may be applied to the articles and/or methods and in the steps or in the sequence of steps of the method described herein without departing from the concept, spirit and scope of the presently disclosed and claimed inventive concept(s). All such similar substitutes and modifications apparent to those skilled in the art are deemed to be within the spirit, scope and concept of the presently disclosed and claimed inventive concept(s) as defined by the appended claims.

As utilized in accordance with the present disclosure, the following terms, unless otherwise indicated, shall be understood to have the following meanings:

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects. For example but not by way of limitation, when the term “about” is utilized, the designated value may vary by plus or minus twelve percent, or eleven percent, or ten percent, or nine percent, or eight percent, or seven percent, or six percent, or five percent, or four percent, or three percent, or two percent, or one percent. The use of the term “at least one” will be understood to include one as well as any quantity more than one, including but not limited to, 2, 3, 4, 5, 10, 15, 20, 30, 40, 50, 100, etc. The term “at least one” may extend up to 100 or 1000 or more, depending on the term to which it is attached; in addition, the quantities of 100/1000 are not to be considered limiting, as higher limits may also produce satisfactory results. In addition, the use of the term “at least one of X, Y and Z” will be understood to include X alone, Y alone, and Z alone, as well as any combination of X, Y and Z. The use of ordinal number terminology (i.e., “first”, “second”, “third”, “fourth”, etc.) is solely for the purpose of differentiating between two or more items and is not meant to imply any sequence or order or importance to one item over another or any order of addition, for example.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, the term “substantially” means that the subsequently described event or circumstance occurs at least 90% of the time, or at least 95% of the time, or at least 98% of the time.

Turning now to the presently disclosed and claimed inventive concept(s), in one embodiment, a collapsible and/or erectable shape-sustaining container for a flower pot or a floral grouping is provided. It is to be understood that while the terms “collapsible” or “erectable” may be used herein with respect to a particular embodiment of a shape-sustaining container, one of ordinary skill in the art would easily understand and could easily adapt the containers described herein to be “collapsible”, “erectable”, or both, and therefore such terms should be understood as being used interchangeably herein. As such, collapsible shape-sustaining containers, erectable shape-sustaining containers, and collapsible and erectable shape-sustaining containers are all fully within the scope of the presently disclosed and claimed inventive concept(s), and the use of the term “collapsible” should be understood to also include containers that are “erectable”, while use of the term “erectable” should be understood to also include containers that are “collapsible”.

In one embodiment, the presently disclosed and claimed inventive concept(s) is directed to an erectable and/or collapsible shape-sustaining container. The container comprises a base portion having a substantially erect condition and a substantially collapsed condition. The term “substantially erect condition” as used herein will be understood to include any condition in which the base portion is provided with a receiving space which is capable of receiving at least one of a flower pot, a floral grouping, a plant, a propagule, growing medium and a floral holding material. The term “substantially collapsed condition” as used herein will be understood to include any condition that occupies less space and/or volume than the substantially erect condition, and therefore is not limited to a flattened or completely collapsed condition.

The base portion of the erectable and/or collapsible shape-sustaining container has an upper end, a lower end, and a sidewall, and at least a portion of the sidewall has at least one condition modifying element to facilitate erecting the container from the substantially collapsed condition to the substantially erect condition or to facilitate collapsing the container from the substantially erect condition to the substantially collapsed condition.

The term “condition modifying element” as used herein will be understood to refer to any element that is capable of facilitating erecting or collapsing of the container. Examples of condition modifying elements that may be utilized in accordance with the presently disclosed and claimed inventive concept(s) include, but are not limited to, score lines, hinges, concentric sections, interlocking concentric sections, pivotally interlocking sections, sections of material which are thinner than the remainder of the base portion, sections of material which are more flexible than the remainder of the base portion, pleats, folds, perforations, creases, voids, partially or wholly cut through areas, removed portions of material, a V-shaped or U-shaped member, excess material, flexible material, stretchable material, and combinations thereof.

The collapsible and/or erectable shape-sustaining container may further comprise a bottom that may be open or substantially closed. The bottom may further have at least one drain opening therein, and the base portion may be capable of substantially retaining liquid in the receiving space thereof. The bottom may be integrally formed with the base portion, or the bottom may be separately formed from the base portion and attached at a later point. In addition, the bottom may not be attached to the base portion until the base portion is in the substantially erect condition.

Alternatively, the bottom may also be provided with a substantially collapsed condition and a substantially erect condition, and may also include at least one condition modifying element as described herein above to facilitate collapsing the container from the substantially erect condition to the substantially collapsed condition or to facilitate erecting the container from the substantially collapsed condition to the substantially erect condition.

While the condition modifying elements described herein facilitate erecting or collapsing of the container of the presently disclosed and claimed inventive concept(s), they may or may not function to maintain the containers of the presently disclosed and claimed inventive concept(s) in such a condition. Therefore, the containers of the presently disclosed and claimed inventive concept(s) may further include at least one shape-sustaining member for maintaining the containers of the presently disclosed and claimed inventive concept(s) in the substantially erect condition and/or the substantially collapsed condition. The term “shape-sustaining member” includes any element that is capable of maintaining the container in the substantially erect condition and/or the substantially collapsed condition. The shape-sustaining member may be endogenously formed with any portion of the container, such as the base portion, bottom, or the skirt or upper portions (as will be described in further detail herein below). Examples of shape-sustaining members that may be utilized in accordance with the presently disclosed and claimed inventive concept(s) includes, but are not limited to, non-scored areas, non-hinged areas, ringed areas, ratchets, rolled areas, hinged areas, domed areas, excess material, adhesive, cohesive, shrink material, stretch material, expandable material, offset condition modifying elements, and combinations thereof.

In one exemplary embodiment, the bottom of the container may be provided with excess material therein that serves as a locking mechanism in the substantially erect condition. This excess material may have to be forced over center outwardly or inwardly (i.e., convex or concave) to be at rest and thereby lock the container in the substantially erect condition. The terms “shape-sustaining member” and “locking member” may be used interchangeably herein.

The collapsible and/or erectable shape-sustaining container may be provided with decorative patterns, designs and/or colors disposed on at least a portion thereof. For example but not by way of limitation, the collapsible and/or erectable shape-sustaining container may be provided with at least one of a printed pattern thereon, an embossed pattern thereon, a three-dimensional pattern thereon, a holographic image thereon, a printed pattern including shaded and highlighted areas which provide the printed pattern with a three dimensional appearance, a substantially matte finish thereon, an iridescent finish thereon, a textured finish thereon, and combinations thereof.

While certain containers of the presently disclosed and claimed inventive concept(s) are illustrated herein as having a generally cylindrical or frusto-conical shape, it is to be understood that the containers of the presently disclosed and claimed inventive concept(s) may be provided with any shape, as long as the container is able to function in accordance with the presently disclosed and claimed inventive concept(s) and is capable of assuming substantially erect and substantially collapsed conditions. In addition, the containers may be provided with bottoms which may have any desired shape, including but not limited to, round, oval, elliptical, square, rectangular, triangular, hexagonal, octagonal, or various other polygonal shapes.

The base portion of the erectable and/or collapsible shape-sustaining container may be formed of a rigid or substantially flexible material. Any material that can be provided with at least one condition modifying element to facilitate in collapsing and/or erecting the shape-sustaining container may be utilized in accordance with the presently disclosed and claimed inventive concept(s). For example but not by way of limitation, the collapsible and/or erectable shape-sustaining container may be constructed of natural polymers, synthetic polymers, plastic, paper, cardboard, cloth, metallized film, foil, metal, clay, feathers, peat moss, wood, or combinations, aggregates or laminations thereof. Also, the base portion may be substantially smooth, substantially textured, or combinations thereof, and the base portion may be free of folds, such as but not limited to, overlapping folds, when in the substantially erect condition, the substantially collapsed condition, or both.

The erectable and/or collapsible shape-sustaining container may further include a skirt portion positioned about the sidewall of the base portion and extending from the base portion. The skirt portion may be substantially flexible and may extend angularly from the base portion. The skirt portion may be connected to at least one of the outer and inner surfaces of the sidewall of the base portion. Optionally, the skirt portion may further include an inner layer connected to the inner surface of the sidewall of the base portion, and an outer layer connected to the outer surface of the sidewall of the base portion. In another embodiment, the base portion and the skirt portion are integrally formed. The skirt portion may flare inwardly or outwardly.

The erectable and/or collapsible shape-sustaining container may further include an upper portion attached to at least a portion of the base and/or skirt portions of the erectable shape sustaining container. The erectable and/or collapsible shape-sustaining container may only be provided with a base portion and an upper portion (without a skirt portion), or the erectable and/or collapsible shape-sustaining container may be provided with a base portion, a skirt portion and an upper portion. The upper portion may be removable from the erectable and/or collapsible shape-sustaining container.

The upper ends of the base portion, skirt portion and upper portion may be provided with a linear upper edge, a non-linear upper edge or a simulated contoured upper edge. The term “simulated contoured upper edge” refers to an upper edge that has a different configuration than a print, pattern or color disposed below or substantially adjacent the upper edge so that the upper edge has the appearance of having the configuration of the print, pattern or color. Examples of simulated contoured upper edges that may be utilized in accordance with the presently disclosed and claimed inventive concept(s) are disclosed in U.S. Pat. No. 6,023,885, issued to Weder on Feb. 15, 2000; U.S. Pat. No. 6,199,320, issued to Weder on Mar. 13, 2001; U.S. Pat. No. 6,345,467, issued to Weder on Feb. 12, 2002; U.S. Pat. No. 6,412,219, issued to Weder on Jul. 2, 2002; U.S. Pat. No. 6,539,667, issued to Weder on Apr. 1, 2003; U.S. Pat. No. 6,568,129, issued to Weder on May 27, 2003; U.S. Pat. No. 6,701,668, issued to Weder on Mar. 9, 2004; and U.S. Pat. No. 6,705,046, issued to Weder on Mar. 16, 2004; the contents of each of which are hereby expressly incorporated herein by reference in their entirety. However, the following references are not to be considered as limiting, and other methods of providing a “simulated contoured upper edge” are also known in the art and therefore are also within the scope of the presently disclosed and claimed inventive concept(s).

In one embodiment, the erectable and/or collapsible shape-sustaining container of the presently disclosed and claimed inventive concept(s) may function as a flower pot cover or plant cover into which a flower pot or plant may be disposed. In another embodiment, the erectable and/or collapsible shape-sustaining container of the presently disclosed and claimed inventive concept(s) may function as a flower pot into which at least one of a natural plant, an artificial plant, growing medium and floral holding material may be disposed. In yet another embodiment, the erectable and/or collapsible shape-sustaining container of the presently disclosed and claimed inventive concept(s) may function as a vase into which at least one of a natural cut flower, an artificial cut flower, and green material may be disposed.

The erectable and/or collapsible shape-sustaining containers of the presently disclosed and claimed inventive concept(s) may be provided singly, or the erectable and/or collapsible shape-sustaining containers of the presently disclosed and claimed inventive concept(s) may be provided in the form of an assembly of a plurality of erectable shape-sustaining containers. When provided in such assembly, the erectable and/or collapsible shape-sustaining containers may further include an assembly tab for connecting the plurality of erectable shape-sustaining containers to form the assembly thereof.

In yet another embodiment, the erectable and/or collapsible shape-sustaining container of the presently disclosed and claimed inventive concept(s) may further include at least one of a banding element and a bonding material disposed on at least a portion thereof.

The erectable and/or collapsible shape-sustaining containers of the presently disclosed and claimed inventive concept(s) may be produced by a thermoforming process, an injection-molding process, a blow-molding process, a casting process, a drawing process, a stamping process, a rolling process or combinations thereof. Such methods of production are well known in the art, and therefore it is clearly within the ability of a person having ordinary skill in the art to identify and utilize such known methods to produce the erectable and/or collapsible shape-sustaining containers of the presently disclosed and claimed inventive concept(s). In one exemplary but not limiting embodiment, the erectable and/or collapsible shape-sustaining container may be produced by a rolling process utilizing machinery produced by Paper Machine Corporation (Milwaukee, Wis.).

The containers of the presently disclosed and claimed inventive concept(s) may be constructed from a substantially rigid material, such as but not limited to, ceramic, clay, concrete, plastic, metal, wood, rock or combinations thereof. Optionally, the containers of the presently disclosed and claimed inventive concept(s) may be constructed from a substantially flexible material, such as but not limited to, natural or synthetic polymers, plastic, paper, cardboard, cloth, metallized film, foil, metal, clay, and combinations and laminations thereof. In yet another embodiment, the containers of the presently disclosed and claimed inventive concept(s) may be constructed of a combination of a substantially rigid material and a substantially flexible material. In addition, at least a portion of the sidewall or bottom of the containers of the presently disclosed and claimed inventive concept(s) (including a base, skirt or upper portion thereof) can be decorated in various colors, finishes, and decorative designs, such as but not limited to, printing, embossing, texturing, matting, iridescent finishes, a three-dimensional pattern, a holographic image, a printed pattern including shaded, and highlighted areas which provide the printed pattern with a three-dimensional appearance, and combinations thereof. Also, at least a portion of the sidewall of bottom of the containers of the presently disclosed and claimed inventive concept(s) (including a base, skirt or upper portion thereof) can be provided with a texture or appearance simulating the texture or appearance of one or more of the following materials: paper, cloth, metal, ceramic, wood, rock, cement, concrete, stone, and combinations thereof.

Particular embodiments of the presently disclosed and claimed inventive concept(s) are described herein after with respect to the Drawings. However, before explaining at least one embodiment of the presently disclosed and claimed inventive concept(s) in detail, it is to be understood that the presently disclosed and claimed inventive concept(s) is not limited in its application to the details of construction and the arrangement of the components set forth in the following description or illustrated in the appended drawings. The presently disclosed and claimed inventive concept(s) is capable of other embodiments or of being practiced or carried out in various ways that would be appreciated by one of ordinary skill in the art as being encompassed by the scope of the presently disclosed and enabled inventive concept(s). Also, it is to be understood that the phraseology and terminology employed herein is for the purpose of description and should not be regarded as limiting.

It is also to be understood that various embodiments shown herein will be described as being provided with particular condition modifying elements, such as but not limited to, score lines, hinges and the like. However, it is to be understood that any of the condition modifying elements described herein may be substituted for the particular condition modifying elements described in conjunction with the Drawings, and therefore the scope of the presently disclosed and claimed inventive concept(s) includes any of the embodiments illustrated in the Figures utilized with any of the condition modifying elements described herein.

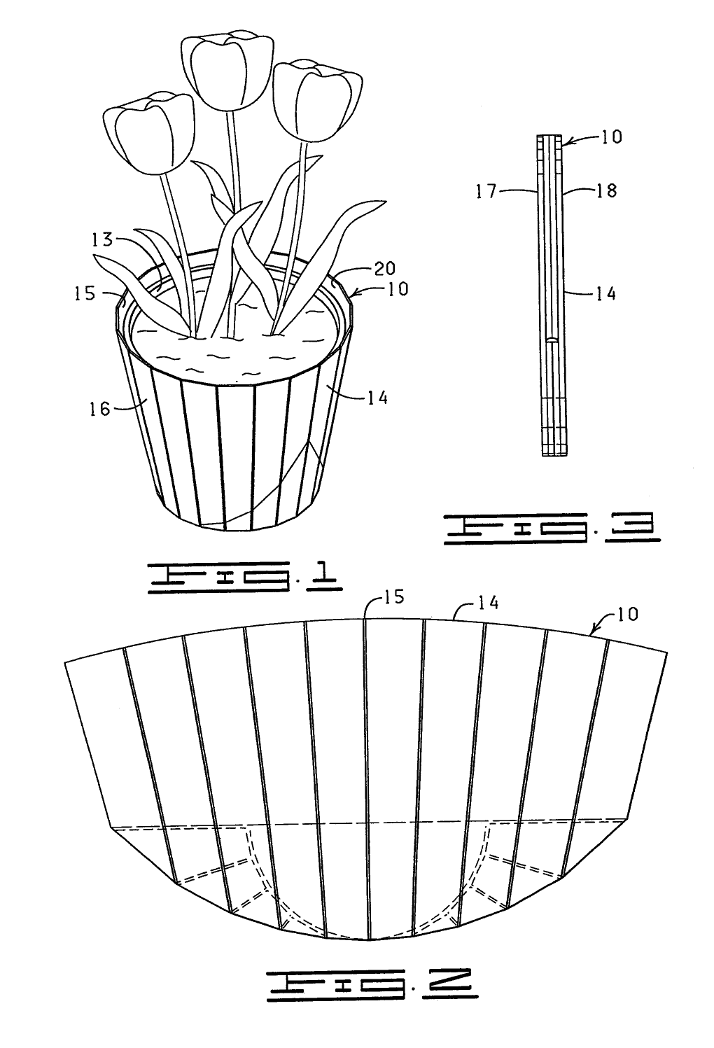

Referring now to the Drawings, and more particularly to FIGS. 1-3, shown therein is a collapsible and/or erectable container 10 constructed in accordance with the presently disclosed and claimed inventive concept(s). The collapsible and/or erectable container 10 includes a plurality of segments 14 and a connecting member 15 for connecting the segments 14 such that the segments 14 define a sidewall 16 and such that the segments 14 are movable between an expanded or substantially erect condition (FIG. 1) and a substantially collapsed condition (FIGS. 2 and 3). In the expanded condition, the segments 14 cooperate with one another to form an object receiving space 20 and to provide the sidewall 16 with a unitary appearance. In the collapsed condition, the sidewall 16 is substantially flattened. The collapsible and/or erectable container 10 illustrated in FIG. 1 is in the expanded position and is configured to cover an object, such as a flower pot 13. However, it is to be understood that the collapsible and/or erectable container 10 is not limited to use as a flower pot cover, but rather may be utilized in any manner described herein.

While the container 10 is depicted as having separate segments 14, it is to be understood that any condition modifying element described herein may be utilized in accordance with the presently disclosed and claimed inventive concept(s), and therefore the container 10 may, in one embodiment, be formed of a unitary construction and having score lines or areas of excess therebetween as opposed to separate segments.

The connecting member 15 of the collapsible and/or erectable container 10 is illustrated as being a flexible liner 22. As best shown in FIG. 4, the flexible liner 22 has an open upper end 24, a closed lower end 26, an inner surface 28, an outer surface 30, and an object receiving space 32. The flexible liner 22 is provided with a gusset 21 to permit the flexible liner 22 to be moved between an expanded condition and a collapsed condition. The flexible liner 22 can be constructed from a suitable flexible and durable material, and particularly from a waterproof material to prevent leakage from the collapsible and/or erectable container 10. The bottom of the flexible liner 22 is illustrated as not being covered with segments. However, it will be appreciated that the bottom of the flexible liner 22 can be provided with segments.

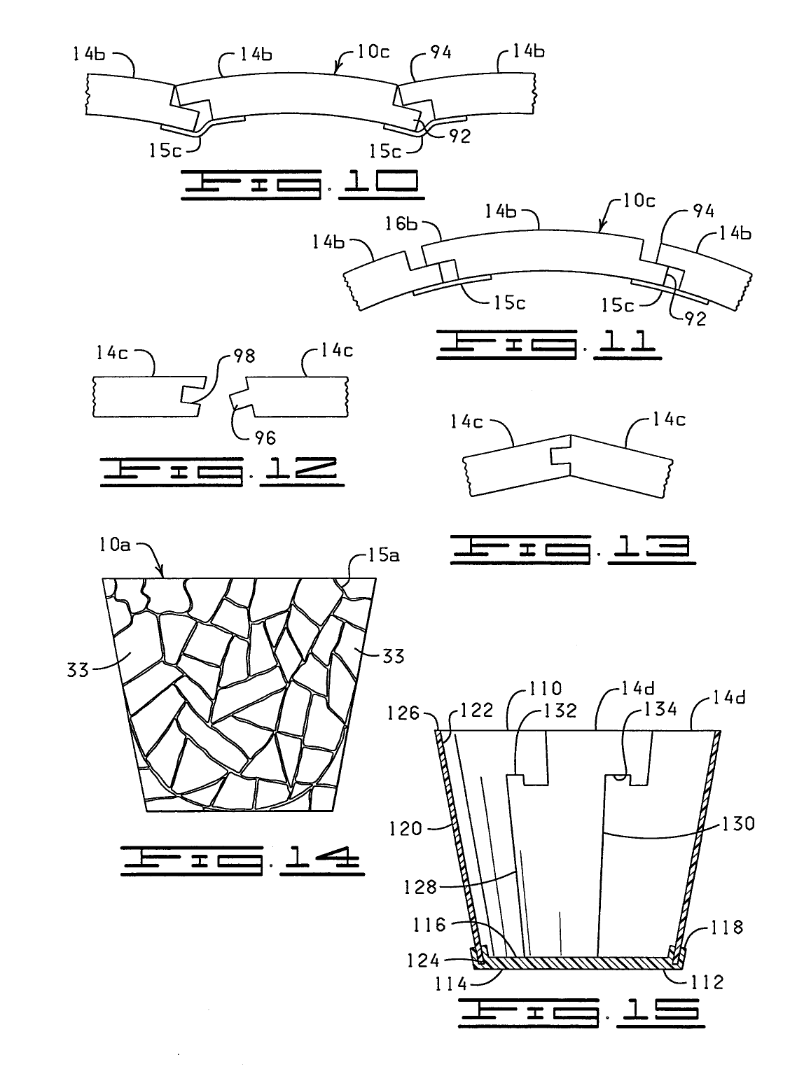

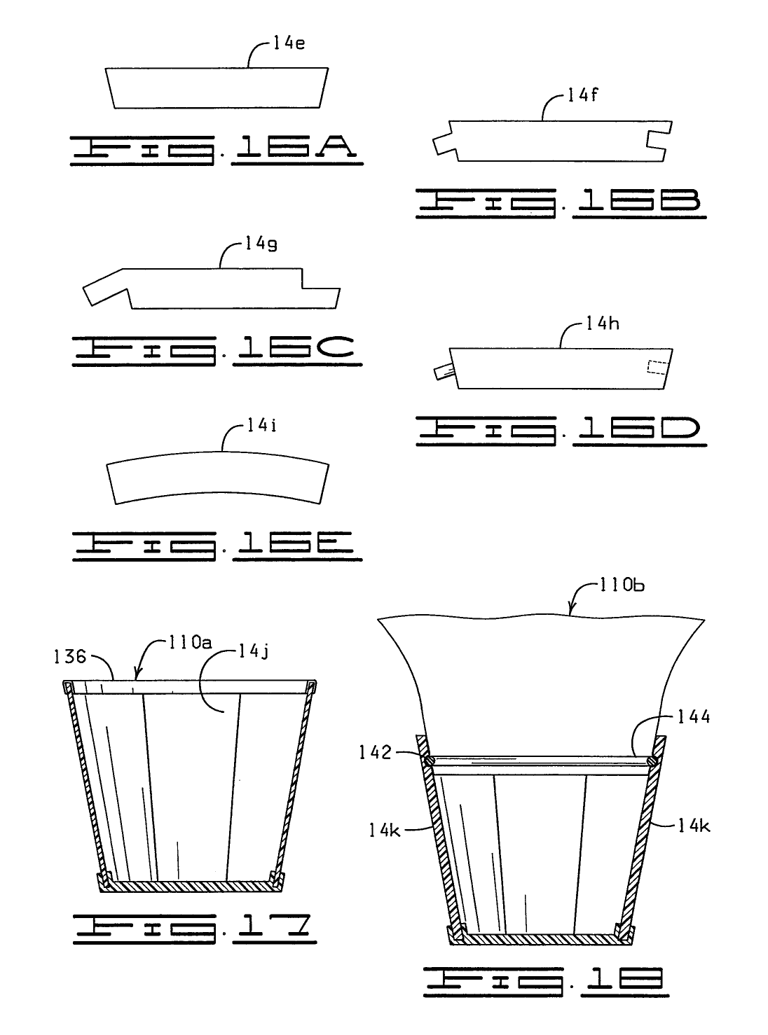

The segments 14 of the collapsible and/or erectable container 10 are of a substantially planar configuration with square edges. However, the segments can also be of a substantially curved configuration as shown in FIG. 16E or irregular configurations, as shown in FIG. 14, so as to provide a mosaic appearance. More specifically, FIG. 14 illustrates a collapsible and/or erectable container 10a which includes a plurality of segments 33 attached to a connecting member 15a. The connecting member 15a is shown to be substantially similar to the connecting member 15 described above. In addition, the segments can be provided with angled edges or tongued and grooved edges, as will be described below. The segments 14 may be constructed from a substantially rigid material, such as but not limited to, ceramic, clay, concrete, plastic, metal, wood, rock, or combinations thereof. Optionally, the segments 14 may be constructed from a substantially flexible material, such as but not limited to, natural or synthetic polymers, plastic, paper, cardboard, cloth, metallized film, foil, metal, clay, and combinations and laminations thereof. In yet another embodiment, the segments 14 may be formed of a combination of a substantially rigid material and a substantially flexible material. In addition, the segments can be decorated in various colors, finishes and decorative designs, such as but not limited to, printing, embossing, texturing, matting, iridescent finishes, a three-dimensional pattern, a holographic image, a printed pattern including shaded and highlighted areas which provide the printed pattern with a three-dimensional appearance, and combinations thereof.

The inner surface of the segments 14 are fixed to the outer surface 30 of the flexible liner 22 via a bonding material. The segments 14 are shaped and arranged so as to permit the segments 14 to move between the expanded condition (FIG. 1) and the collapsed condition (FIGS. 2 and 3) in conjunction with the flexible liner 22. The segments 14 of substantially planar or curved configurations are aligned on the flexible liner 22 such that longitudinal edge of one segment 14 substantially parallels the longitudinal edge of the adjacent segment 14. To this end, the flexible liner 22 serves as a hinge between the segments 14 thereby allowing the collapsible and/or erectable container 10 to be moved between the expanded condition and the collapsed condition.

The collapsible and/or erectable container 10 is maintained in the expanded condition upon disposing the flower pot 13, or some other support member, such as soil, into the object receiving space 20.

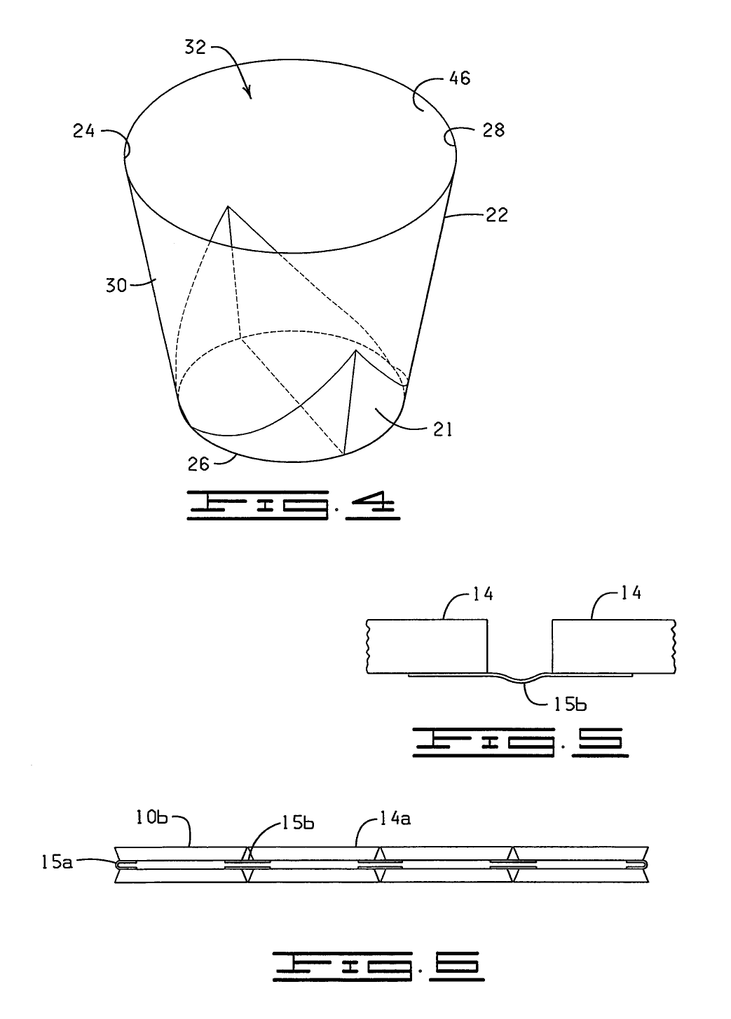

FIGS. 5-9 illustrate that the segments 14 can also be connected with a material that can be repeatedly flexed without fatiguing, such as polypropylene, so as to provide a living hinge. More specifically, FIG. 5 shows the segments 14 connected with a connecting member 15b, and FIGS. 6-7 show a collapsible and/or erectable container 10b. The collapsible and/or erectable container 10b includes a plurality of segments 14a and the plurality of connecting members 15b for connecting the segments 14a such that the segments 14a define a sidewall 16a and such that the segments 14a are movable between an expanded condition (FIG. 7) and a collapsed condition (FIG. 6). In the expanded condition, the segments 14a cooperate with one another to form an object receiving space 20a and to provide the sidewall 16a with a unitary appearance. In the collapsed condition, the sidewall 16a is substantially flattened. To provide a more unitary appearance, the ends of the segments 14a are angled so that the ends of the segments 14a abut in the expanded condition.

The connecting members 15b are illustrated as being elastic living hinges wherein each living hinge has one portion connected to one of the segments 14a and another portion connected to an adjacent segment 14a. The connecting members 15b connect the inner surface of one segment 14a together with the inner surface of the adjacent segment 14a. The elasticity of the living hinges biases the segments 14a in the expanded condition, yet permits the segments 14a to be moved to the collapsed condition.

FIG. 8 illustrates a connecting member 15c which is non-elastic. As such, the segments 14a are not biased in the expanded condition and the segments 14a will be spaced apart in the expanded condition a sufficient distance to permit the segments 14a to be moved to the collapsed condition.

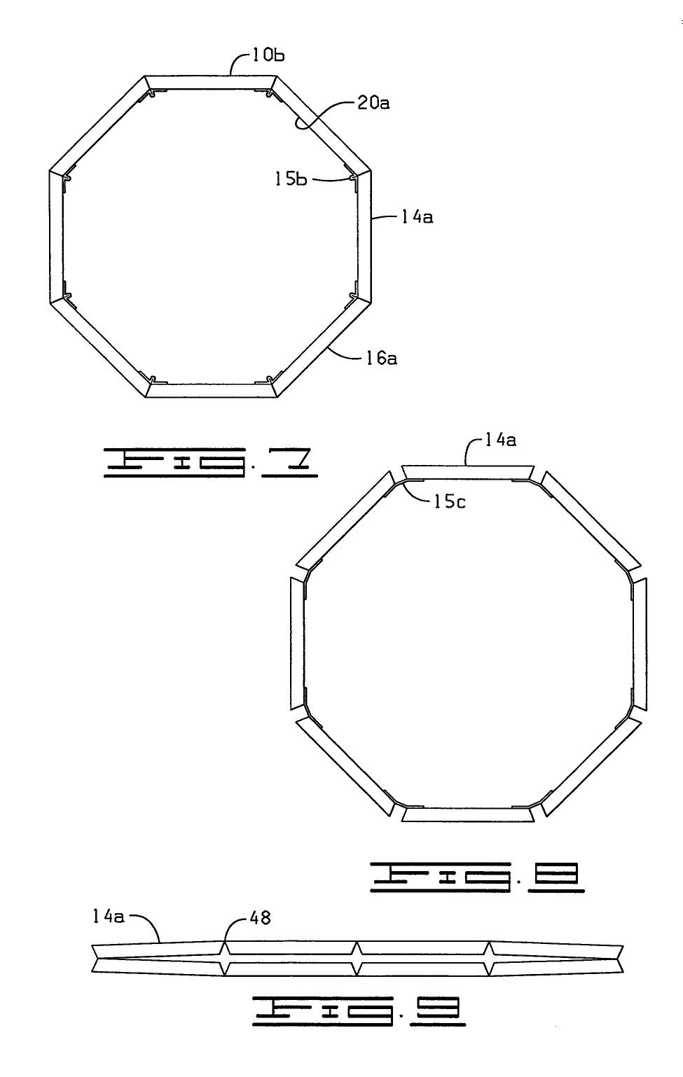

As shown in FIG. 9, the segments 14a can also be molded as a single piece with a thinned area or score line 48 provided between adjacent segments 14a to permit the segments 14a to expand and collapse relative to one another.

FIGS. 10 and 11 illustrate a portion of another embodiment of a collapsible and/or erectable container 10c which includes a plurality of segments 14b and a plurality of connecting members 15c for connecting the segments 14b such that the segments 14b define a sidewall 16b and such that the segments 14b are movable between an expanded condition (FIG. 11) and a collapsed condition (FIG. 10). The segments 14b are provided with an arcuate configuration. The segments 14b are further illustrated as having an inner lip 92 formed on one end and an outer lip 94 formed on the opposite end. The inner and outer lips 92 and 94 overlap so as to cooperate to interlock the segments 14b in the expanded condition.

The connecting member 15c is an elastic member having one portion connected to one of the segments 14b and another portion connected to an adjacent segment 14b so as to bias the segments 14b in the expanded condition, yet permit the segments 14b to be moved to the collapsed position.

FIGS. 12 and 13 illustrate another embodiment of segment 14c wherein the segments 14c include a tongue 96 on one end and a corresponding groove 98 on the opposite end. The tongue 96 and groove 98 are configured to interlock together when the segments 14c are in the expanded condition. These interlocking features provide the desired shape and add strength to the collapsible and/or erectable container in its expanded position.

FIGS. 16A-16E illustrate various other embodiments of segments 14e-14i that can be utilized in construction of the collapsible and/or erectable container in accordance with the presently disclosed and claimed inventive concept(s).

FIG. 15 shows a sectional view of a container assembly 110. The container assembly 110 includes a base member 112 having a bottom surface 114, a top surface 116, and a groove 118 formed along an outer perimeter thereof. The container assembly 110 further includes a plurality segments 14d having one end removably disposed in the groove 118 of the base member 112 arranged circumferentially about the base member 112 to form a sidewall 120. The sidewall 120 cooperates with the base member 112 to define an object receiving space 122. Each segment 14d has a lower edge 124, an upper edge 126, a first side edge 128, and a second side edge 130. The first side edge 128 of each segment 14d is detachably linked to the second side edge 130 of an adjacent rigid segment 14d with the rigid segments 14d disposed in the groove 118 of the base member 112. The first side edge 128 of each rigid segment 14d has a tongue 132 and the second side edge 130 of each rigid segment 14d has a groove 134 for receiving the tongue 132 of the adjacent rigid segment 14d.

As shown in FIG. 17, a container assembly 110a includes an annular clip 136 positioned over the upper edge of segments 14j so as to link each of the segments 14j together. As shown in FIG. 20, the annular clip 136 can also be utilized to secure a flexible sheet of material 138 having a portion secured between the upper edge of the segments 14j and the annular clip 136 and another portion extending from the segments 14j so as to define a skirt 140. Another annular clip 136 can be secured to the lower edges 124 of the segments 14j in substitution of the base member 112 to provide an open bottom container. Instead of a single clip, a plurality of clips 136a can be used to link the segments 14j, as illustrated in FIG. 21.

In another embodiment of a container assembly 110b, as shown in FIG. 18, segments 14k have a groove 142 formed on an interior surface thereof which is alignable with the grooves of the other segments 14k to form and annular groove in the interior surface of the sidewall adapted to receive an elastic ring member 144 which is biased against the interior surface of the sidewall formed by the segments 14k.

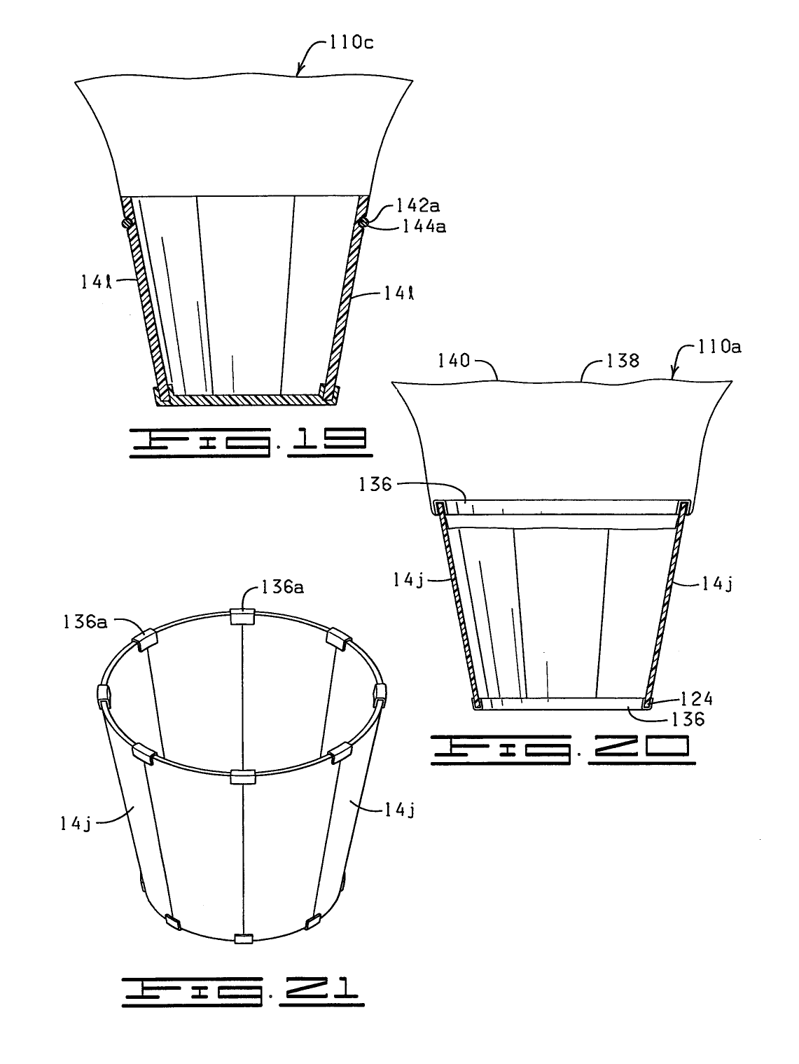

In yet another embodiment of a container assembly 110c, as shown in FIG. 19, segments 141 have a groove 142a formed on an exterior surface thereof which is alignable with the grooves of the other segments 141 to form an annular groove in the exterior surface of the sidewall adapted to receive an elastic ring member 144a which is biased against the exterior surface of the sidewall formed by the segments 141.

FIG. 22 illustrates another embodiment of another container assembly 110d wherein a groove 118a is defined by a peripheral lip 150 of a base member 112a and an insert 152 positioned in a lower end of an object receiving space 120a. The insert 152 is dimensioned such that the lower edge of segments 14j are supportingly received between the peripheral lip 150 of the base member 112a and a peripheral edge of the insert 152.

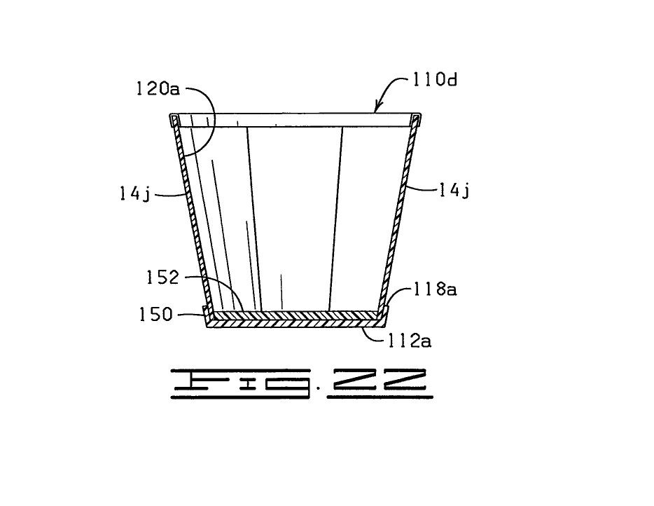

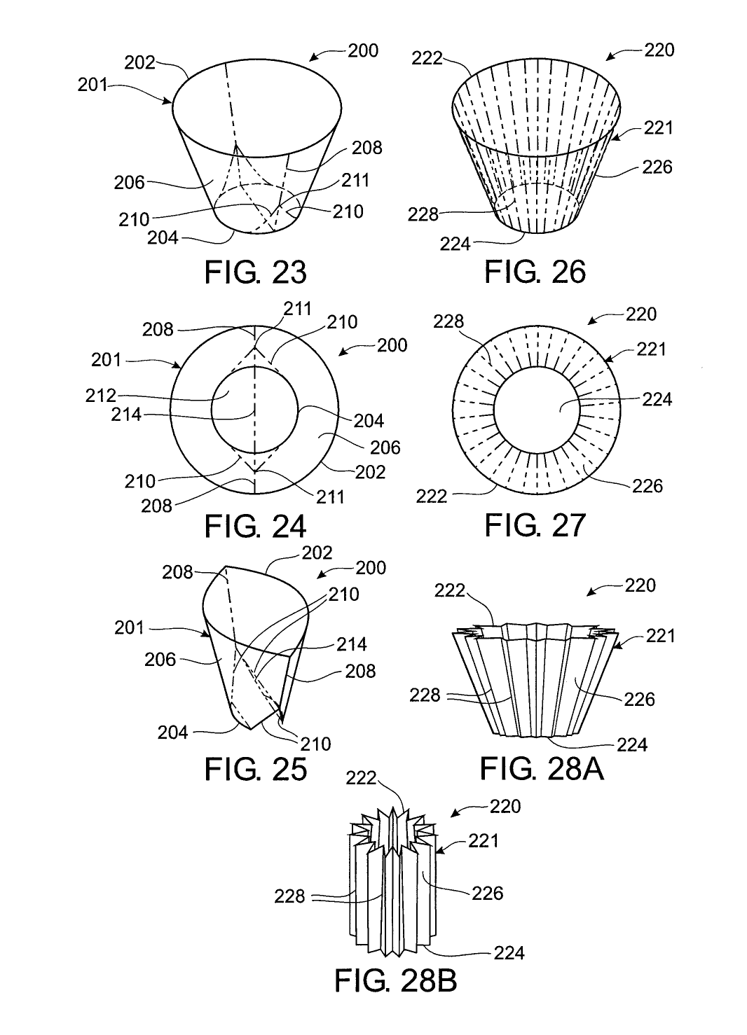

FIGS. 23-25 illustrate another embodiment of the presently disclosed and claimed inventive concept(s). Shown in FIG. 23 is a collapsible and/or erectable shape-sustaining container 200 in a substantially erect condition. The container 200 comprises a base portion 201 that includes an upper end 202, a lower end 204 and a sidewall 206. The sidewall 206 of the base portion 201 of the container 200 has at least one condition modifying element, such as a score line 208, extending generally from the upper end 202 to the lower end 204 thereof. As is illustrated in FIG. 24, the base portion 201 of the container 200 is provided with two score lines 208 formed therein, wherein the two score lines 208 are disposed on opposite sides of the sidewall 206 of the base portion 201 of the container 200.

The sidewall 206 of the base portion 201 of the container 200 may be provided with other condition modifying elements disposed thereon. For example, the sidewall 206 of the base portion 201 of the container 200 is illustrated as having two V-shaped score lines 210 extending from a point 211 formed in a lower portion of the sidewall 206 of the base portion 201 of the container 200 generally diagonally to the lower end 204 of the base portion 201 of the container 200. The two V-shaped score lines 210 are disposed on opposite sides of the sidewall 206, as shown in FIG. 24, and the point 211 of each of the V-shaped score lines 210 intersects the vertically-extending score line 208 on each side of the sidewall 206 of the container 200. The score lines 208 and 210 cooperate to facilitate collapsing the sidewall 206 of the base portion 201 of the container 200.

The container 200 may further comprise a bottom 212 formed therein, as illustrated in FIG. 24. The bottom 212 is also provided with a condition modifying element, such as a score line 214, extending generally across a diameter of the bottom 212. The score line 214 is illustrated as extending between the two score lines 208 formed in opposite sides of the sidewall 206 of the base portion 201 of the container 200. The score line 214 facilitates in collapsing the bottom 212 of the base portion 201 of the container 200.

FIG. 25 illustrates the container 200 of FIGS. 23 and 24 in a substantially collapsed condition, wherein the score lines 208, 210 and 214 facilitate in collapsing the sidewall 206 and the bottom 212 of the base portion 201 of the container 200.

It is to be understood that the container 200 illustrated in FIGS. 23-25 may further be provided with a skirt portion and/or an upper portion, as described in detail herein, and therefore a container 200 comprising the base portion 201 as well as a skirt portion and/or an upper portion is also within the scope of the presently disclosed and claimed inventive concept(s).

One or more of the score lines, 208, 210 and 214, which are described herein as functioning as condition modifying elements, may also function as a shape-sustaining member for maintaining the container 200 in the substantially collapsed and/or substantially erect condition. Optionally, the container 200 may be provided with another feature that functions as a shape-sustaining member.

FIGS. 26-28 illustrate another embodiment of the presently disclosed and claimed inventive concept(s). Shown in FIG. 26 is a collapsible and/or erectable shape-sustaining container 220 in a substantially erect condition. The container 220 comprises a base portion 221 that includes an upper end 222, a lower end 224 and a sidewall 226. The sidewall 226 of the base portion 221 of the container 220 has a plurality of condition modifying elements, such as a plurality of score lines 228, extending generally from the upper end 222 to the lower end 224 thereof. The plurality of score lines 228 may extend generally vertically from the upper end 222 to the lower end 224 of the base portion 221 of the container 220, or the plurality of score lines 228 may extend in generally diagonally from the upper end 222 to the lower end 224 of the base portion 221 of the container 220, or the plurality of score lines 228 may extend in a combination thereof, as is shown in FIG. 26.

The lower end 224 of the collapsible and/or erectable container 220 may be open, as shown in FIG. 27, or the lower end 224 may be closed with a bottom formed therein, as described in detail in relation to other collapsible and/or erectable containers described herein.

The plurality of score lines 228 would allow the erectable and/or collapsible shape-sustaining container 220 to collapse in more than one manner. Shown in FIGS. 28A and 28B are two exemplary substantially collapsed conditions for the container 220. In FIG. 28A, the container 220 is collapsed into a flattened condition. In FIG. 28B, the container 220 is collapsed into a tubular shape.

It is to be understood that the container 220 illustrated in FIGS. 26-28 may further be provided with a skirt portion and/or an upper portion, as described in detail herein, and therefore a container 220 comprising the base portion 221 as well as a skirt portion and/or an upper portion is also within the scope of the presently disclosed and claimed inventive concept(s).

One or more of the score lines 228, which are described herein as functioning as condition modifying elements, may also function as a shape-sustaining member for maintaining the container 220 in the substantially collapsed and/or substantially erect condition. Optionally, the container 220 may be provided with another feature that functions as a shape-sustaining member.

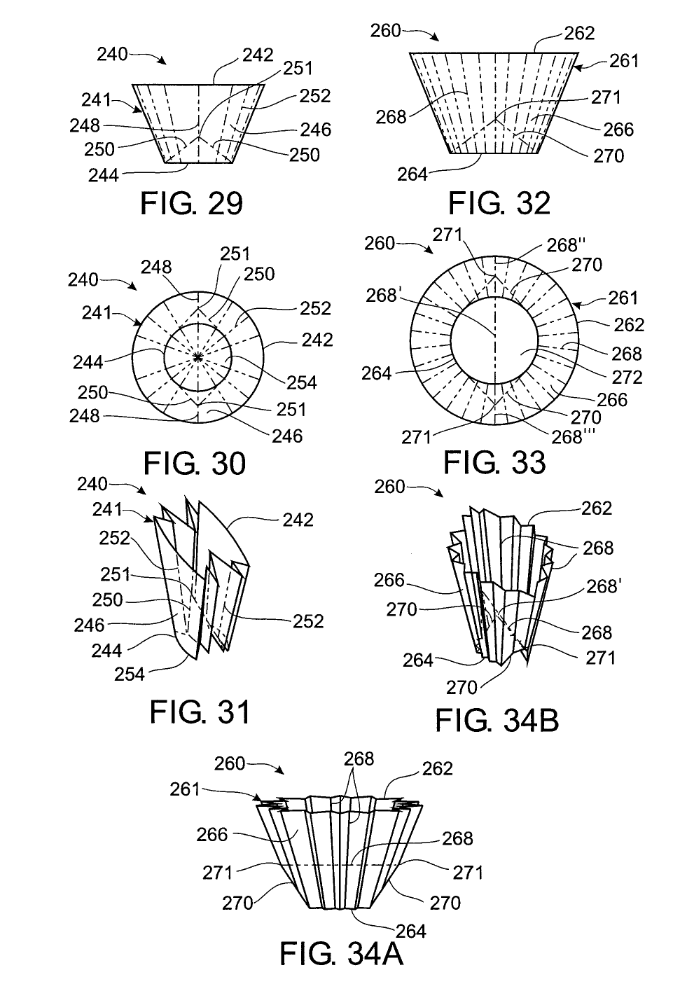

FIGS. 29-31 illustrate another embodiment of the presently disclosed and claimed inventive concept(s). Shown in FIG. 29 is a collapsible and/or erectable shape-sustaining container 240 in a substantially erect condition. The container 240 comprises a base portion 241 that includes an upper end 242, a lower end 244 and a sidewall 246. The container 240 is similar to the container 200 of FIGS. 23-25 and includes at least one condition modifying element, such as a score line 248, extending vertically from the upper end 242 to the lower end 244 thereof, as well as a plurality of condition modifying elements, such as two score lines 250, forming a V-shape that extends from a point 251 formed in a lower portion of the sidewall 246 generally diagonally to the lower end 244 of the base portion 241. The two V-shaped score lines 250 are disposed on opposite sides of the sidewall 246, as shown in FIG. 30, and the point 251 of each of the V-shaped score lines 250 intersects the vertically-extending score line 248 on each side of the sidewall 246 of the container 240. In addition, the sidewall 246 of the base portion 241 of the container 240 further includes a plurality of condition modifying elements, such as a plurality of score lines 252, extending diagonally from the lower end 244 to the upper end 242 thereof. Each of the score lines 248, 250 and 252 are repeated on an opposite side of the sidewall 246 of the base portion 241 of the container 220.

The lower end 244 of the base portion 241 of the container 240 is illustrated in FIG. 30 as being closed with a bottom 254 formed therein. The score lines 248 and 252 also extend across the bottom 254 of the base portion 241 of the container 240 and intersect with their corresponding oppositely disposed score line. The score lines 248 and 252 facilitate in collapsing the base portion 241 and the bottom 254 of the container 240.

FIG. 31 illustrates the container 240 of FIGS. 29 and 30 in a substantially collapsed condition, wherein the score lines 248, 250 and 252 facilitate in collapsing the sidewall 246 of the base portion 241 and the bottom 254 of the container 240. While FIG. 31 illustrates the container 240 as being folded along all of the plurality of score lines 248, 250 and 252, it is to be understood that the container 240 does not have to be folded along all of the plurality of score lines 248, 250 and 252 to assume a substantially collapsed condition. Rather, the container 240 will be defined as being in a “substantially collapsed condition” when folded along one or more of the plurality of score lines 248, 250 and 252.

It is to be understood that the container 240 illustrated in FIGS. 29-31 may further be provided with a skirt portion and/or an upper portion, as described in detail herein, and therefore a container 240 comprising the base portion 241 as well as a skirt portion and/or an upper portion is also within the scope of the presently disclosed and claimed inventive concept(s).

One or more of the score lines 248, 250 and 252, which are described herein as functioning as condition modifying elements, may also function as a shape-sustaining member for maintaining the container 240 in the substantially collapsed and/or substantially erect condition. Optionally, the container 240 may be provided with another feature that functions as a shape-sustaining member.

FIGS. 32-34 illustrate another embodiment of the presently disclosed and claimed inventive concept(s). Shown in FIG. 32 is a collapsible and/or erectable shape-sustaining container 260 in a substantially erect condition. The container 260 comprises a base portion 261 that includes an upper end 262, a lower end 264, and a sidewall 266. The container 260 is similar to the container 220 of FIGS. 26-28 and includes a plurality of condition modifying elements, such as score lines 268, extending generally from the upper end 262 to the lower end 264 thereof. The plurality of score lines 268 may extend generally vertically and/or generally diagonally.

The container 260 differs from the container 220 in that the lower end 264 of the container 260 is closed with a bottom 272 formed therein, as shown in FIG. 33. The bottom 272 of the container 220 is provided with a score line 268′, which extends substantially across a diameter of the bottom 272 of the container and intersects two oppositely, disposed score lines 268″ located in the sidewall 266 of the container 260.

In addition, the sidewall 266 of the container 260 further includes a plurality of condition modifying elements, such as two V-shaped score lines 270, wherein the V-shape extends from a point 271 formed in a lower portion of the sidewall 266 generally diagonally to the lower end 264 of the container 260. The two V-shaped score lines 270 are disposed on opposite sides of the sidewall 266, as shown in FIG. 33, and the point 271 of each of the V-shaped score lines 270 intersects one of the vertically-extending score lines 268″ on each side of the sidewall 266 of the container 260.

The plurality of score lines 268 would allow the erectable and/or collapsible shape-sustaining container 260 to collapse in more than one manner. Shown in FIGS. 34A and 34B are two exemplary substantially collapsed conditions for the container 260. In FIG. 34A, the container 260 is collapsed into a flattened condition. In FIG. 34B, the container 260 is collapsed into a tubular shape.

It is to be understood that the container 260 illustrated in FIGS. 32-34 may further be provided with a skirt portion and/or an upper portion, as described in detail herein, and therefore a container 260 comprising the base portion 261 as well as a skirt portion and/or an upper portion is also within the scope of the presently disclosed and claimed inventive concept(s).

One or more of the score lines 268 and 270, which are described herein as functioning as condition modifying elements, may also function as a shape-sustaining member for maintaining the container 260 in the substantially collapsed and/or substantially erect condition. Optionally, the container 260 may be provided with another feature that functions as a shape-sustaining member.

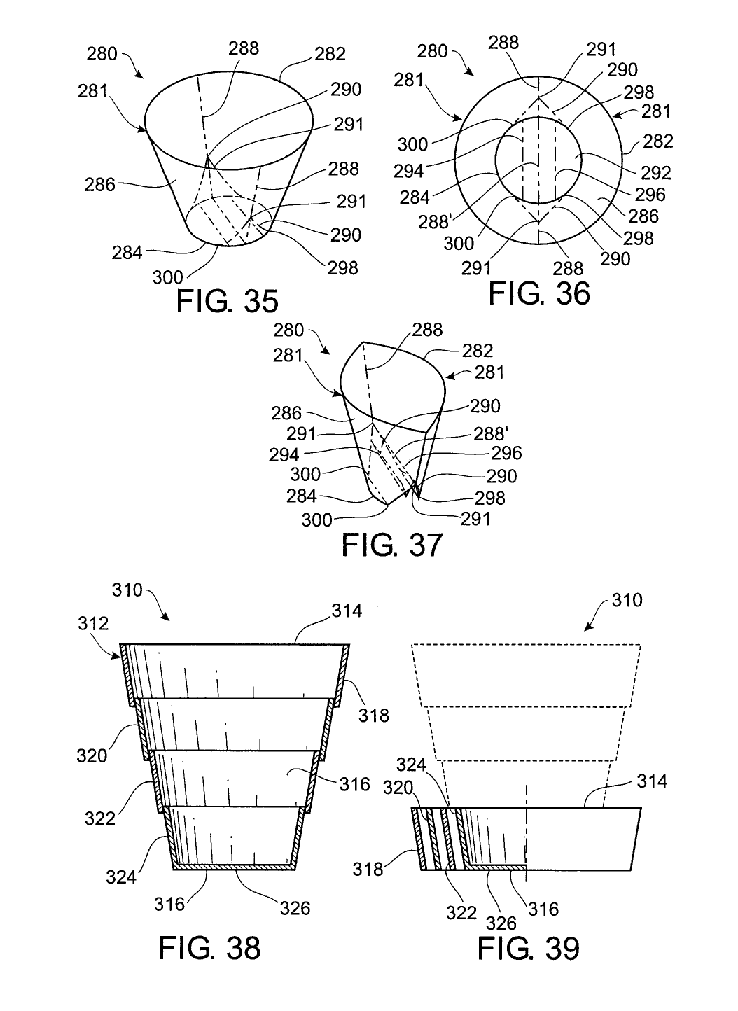

FIGS. 35-37 illustrate another embodiment of the presently disclosed and claimed inventive concept(s). Shown in FIG. 35 is a collapsible and/or erectable shape-sustaining container 280 in a substantially erect condition. The container 280 comprises a base portion 281 having an upper end 282, a lower end 284, and a sidewall 286. The container 280 is similar to the container 200 of FIGS. 23-25 and is provided with at least one condition modifying element, such as two score lines 288, extending generally from the upper end 282 to the lower end 284 thereof and on opposite sides of the container 280 (see FIG. 36). Also like the container 200, the container 280 is further provided with a plurality of V-shaped score lines 290, wherein the V-shape extends from a point 291 formed in a lower portion of the sidewall 286 generally diagonally to the lower end 284 of the container 280. The two V-shaped score lines 290 are disposed on opposite sides of the sidewall 286, as shown in FIG. 36, and the point 291 of each of the V-shaped score lines 290 intersects one of the vertically-extending score lines 288 on each side of the sidewall 286 of the container 280.

The lower end 284 of the container 280 is closed with a bottom 292 formed therein, as illustrated in FIG. 36. The bottom 292 of the container 280 is also provided with a condition modifying element, such as a score line 288′, which spans a diameter of the bottom 292 and intersects the score lines 288 extending on either side of the container 280. The bottom 292 of the container 280 is further provided with two other condition modifying elements, such as score lines 294 and 296. The score lines 294 and 296 do not extend across the diameter of the bottom 292 of the container 280. Instead, score line 294 spans from points 298, at which one of the ends of each of the V-shaped score lines 290 intersect the lower end 284 of the container 280, and score line 296 spans from points 300, at which the other ends of each V-shaped score line 290 intersect the lower end 284 of the container 280.

FIG. 37 illustrates the container 280 of FIGS. 35 and 36 in a substantially collapsed condition, wherein the score lines 288, 288′, 290, 294 and 296 facilitate in collapsing the sidewall 286 of the base portion 281 and the bottom 292 of the container 280. The score lines 288′, 294 and 296 form an inner-fold, such as a gusset, when the container 280 is in the substantially collapsed condition. While FIG. 37 illustrates the container 280 as being folded along all of the plurality of score lines 288, 288′, 290, 294 and 296, it is to be understood that the container 280 does not have to be folded along all of the plurality of score lines 288, 288′, 290, 294 and 296 to assume a substantially collapsed condition. Rather, the container 280 will be defined as being in a “substantially collapsed condition” when folded along one or more of the plurality of score lines 288, 288′, 290, 294 and 296.

It is to be understood that the container 280 illustrated in FIGS. 35-37 may further be provided with a skirt portion and/or an upper portion, as described in detail herein, and therefore a container 280 comprising the base portion 281 as well as a skirt portion and/or an upper portion is also within the scope of the presently disclosed and claimed inventive concept(s).

One or more of the score lines 288, 288′, 290, 294 and 296, which are described herein as functioning as condition modifying elements, may also function as a shape-sustaining member for maintaining the container 280 in the substantially collapsed and/or substantially erect condition. Optionally, the container 280 may be provided with another feature that functions as a shape-sustaining member.

Shown in FIGS. 38-39 is another embodiment of the presently disclosed and claimed inventive concept(s). FIG. 38 depicts a collapsible and/or erectable shape-sustaining container 310 in a substantially erect condition. The container 310 comprises a base portion 311 having an upper end 312, a lower end 314 and a sidewall 316. The sidewall 316 of the container 310 is illustrated in FIGS. 38-39 as being formed of four concentric sections extending from the upper end 312 to the lower end 314 of the container 310: a first section 318, a second section 320, a third section 322, and a fourth section 324. However, it is to be understood that the container 310 may be formed of any number of sections, as long as the container 310 comprises at least two sections. In addition, the sections 318, 320, 322 and 324 are depicted as being concentric sections that interlock in the substantially erect condition, as shown in FIG. 38. However, it should be understood that the container 310 may be provided with any type of interlocking sections that function as condition modifying elements that facilitate in collapsing and/or erecting the container 310. Further, one or more of the concentric sections 318, 320, 322, and 324 may also function as a shape-sustaining member for maintaining the container 310 in the substantially collapsed and/or substantially erect condition, or the container 310 may be provided with another feature that functions as a shape-sustaining member.

FIG. 39 depicts the collapsible and/or erectable shape-sustaining container 310 in a substantially collapsed condition. Collapsing of the container 310 is accomplished by disposing the second section 320 inside the first section 312, disposing the third section 322 inside the second section 320, and disposing the fourth section 324 inside the third section 322. However, it is to be understood that the container 310 will have multiple substantially collapsed conditions, and the container 310 will be considered to be in a substantially collapsed conditions when any of the sections 318, 320, 322 and 324 is disposed in another section. Therefore, it is not required to have the three sections 320, 322 and 324 disposed into the first section 318 for the container 310 to be considered to be in a substantially collapsed condition.

The lower end 314 of the container 310 is illustrated as being closed with a bottom 326 formed therein; however, it is to be understood that the lower end 314 of the container 310 may also be open.

It is to be understood that the container 310 illustrated in FIGS. 38-39 may further be provided with a skirt portion and/or an upper portion, as described in detail herein, and therefore a container 310 comprising the base portion 311 as well as a skirt portion and/or an upper portion is also within the scope of the presently disclosed and claimed inventive concept(s).

One or more of the sections 318, 320, 322 and 324, which are described herein as functioning as condition modifying elements, may also function as a shape-sustaining member for maintaining the container 310 in the substantially collapsed and/or substantially erect condition. Optionally, the container 310 may be provided with another feature that functions as a shape-sustaining member.

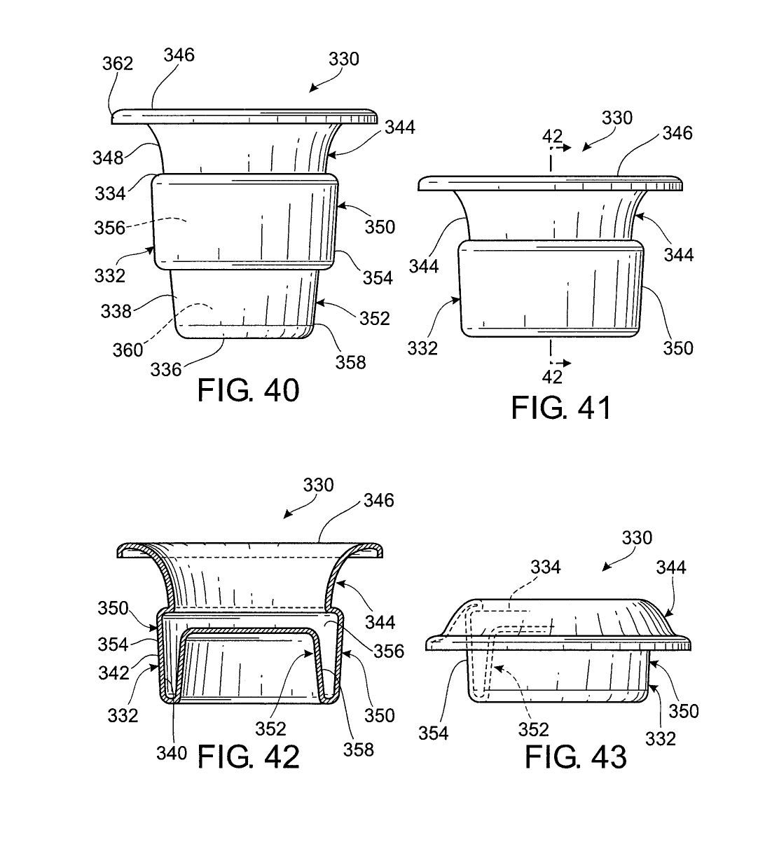

Shown in FIGS. 40-43 is another embodiment of the presently disclosed and claimed inventive concept(s). FIG. 40 illustrates a collapsible and/or erectable shape-sustaining container 330 in a substantially erect condition. The container 330 comprises a base portion 332 having an upper end 334, a lower end 336 (which may or may not be closed with a bottom formed therein), a sidewall 338, and inner peripheral surface 340 and an outer peripheral surface 342 (see FIG. 42). The container 330 further comprises a skirt portion 344 extending from the upper end 334 of the base portion and having an upper end 346 and a sidewall 348. The sidewall 348 of the skirt portion 344 is depicted as being coextensive with the sidewall 338 of the base portion 332; however, it is to be understood that the sidewall 348 of the skirt portion 344 may alternatively be attached to the inner peripheral surface 340 or the outer peripheral surface 342 of the base portion 332.

The base portion 332 of the container 330 is illustrated as further comprising a first section 350 and a second section 352. The first section 350 has a sidewall 354 and an inner receiving space 356, and the second section 352 has a sidewall 358 and an inner receiving space 360. The sidewall 358 of the second section 352 is formed of a material that is thinner and/or more flexible than the sidewall 354 of the first section 350. This allows at least a portion of the sidewall 358 of the second section 352 to fold upwardly and inwardly into the inner receiving space 356 of the first section 350, as illustrated in FIG. 42.

In a similar manner, the sidewall 348 of the skirt portion 344 is also formed of a material that is thinner and/or more flexible than the sidewall 354 of the first section 350 of the base portion 332, thus allowing at least a portion of the sidewall 348 of the skirt portion 344 to fold downwardly and outwardly over the sidewall 354 of the first section 350 of the base portion 332 of the container 330, as illustrated in FIG. 43.

It is to be understood that the container 330 illustrated in FIGS. 40-43 may further be provided with an upper portion which may be attached to the base portion 332 and/or the skirt portion 344 of the container 330, as described in detail herein, and therefore a container 330 comprising the base portion 332 and skirt portion 344 as well as an upper portion is also within the scope of the presently disclosed and claimed inventive concept(s).

One or more of the condition modifying elements of the container 330 (i.e., the sections of material that are thinner and/or more flexible than the other sections of material), may also function as a shape-sustaining member for maintaining the container 330 in the substantially collapsed and/or substantially erect condition. Optionally, the container 330 may be provided with another feature that functions as a shape-sustaining member. For example, the upper end 346 of the skirt portion 344 of the container 330 is provided with a rolled edge 362. Rolled edges are known in the art to be shape-sustaining elements, and therefore the rolled edge 362 of the container 330 may be utilized as a shape-sustaining member to maintain the container 330 in a substantially erect and/or a substantially collapsed condition. In addition, the rolled edge 362 may be utilized with any of the containers described herein or with any containers within the scope of the presently disclosed and claimed inventive concept(s) as a shape-sustaining member for maintaining a container of the presently disclosed and claimed inventive concept(s) is a substantially erect and/or substantially collapsed condition.

While the container 330 is illustrated herein as being formed of three sections of material, it is to be understood that the container 330 may only comprise two sections of material. For example, while the base portion 332 of the container 330 is illustrated as having first and second sections 350 and 352, respectively, it is to be understood that the base portion 332 may be formed of a single section of the same thickness/flexibility of material. This would allow the skirt portion 344, which is formed of a material that is thinner and/or more flexible than the base portion 332, to fold downwardly and inwardly into the inner receiving space 356 of the base portion 332. In yet another alternative embodiment, the container 330 may comprise only the base portion 332 with first and second sections 350 and 352, and may be free of the skirt portion 344.

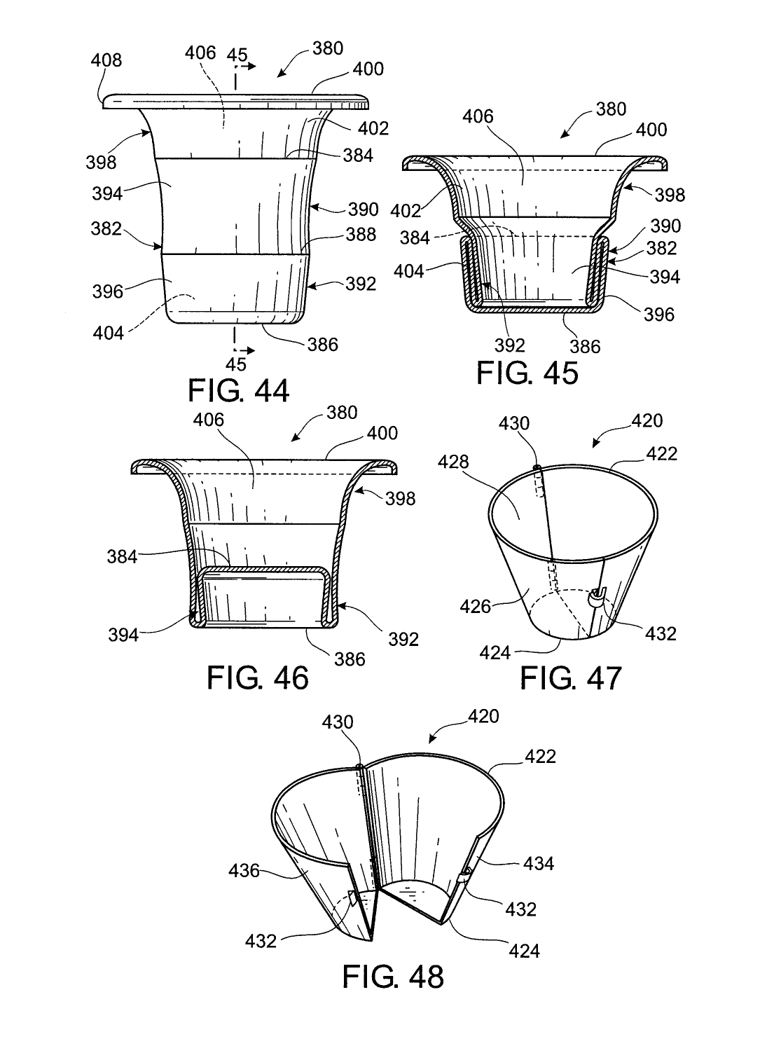

Shown in FIGS. 44-46 is another embodiment of the presently disclosed and claimed inventive concept(s). FIG. 44 depicts a collapsible and/or erectable shape-sustaining container 380 in a substantially erect condition. The container 380 is similar to the container 330 described herein above with reference to FIGS. 41-43. The container 380 comprises a base portion 382 having an upper end 384, a lower end 386, and a sidewall 388. The base portion 382 comprises a first section 390 and a second section 392, wherein the first section 390 has a sidewall 394 and the second section 392 has a sidewall 396. The container 380 further comprises a skirt portion 398 attached to the upper end 384 of the base portion and having an upper end 400 and a sidewall 402.

The base portion 382 of the container 380 is similar to the base portion 332 of the container 330 of FIGS. 40-43, except that the sidewall 394 of the first section 390 is formed of a material that is thinner and/or more flexible than the sidewall 396 of the second section 392 of the base portion 382. In a particular embodiment, the sidewall 394 of the first 390 is also formed of a material that is thinner and/or more flexible than the sidewall 402 of the skirt portion 398. In this manner, when pressure is applied to the upper end 400 of the skirt portion 398 and/or to the lower end 386 of the base portion 382, the sidewall 394 of the first section 390 of the base portion 382 collapses and folds inwardly into an inner receiving space of one of the other sections of the container 380. For example, FIG. 45 depicts the sidewall 394 of the first section 390 as being folded downwardly and inwardly into an inner receiving space 404 of the second section 392. However, it is to be understood that the sidewall 394 of the first section 390 may also fold upwardly and inwardly into an inner receiving space 406 of the skirt portion 398.

In either of the two substantially collapsed conditions described herein above, the two thicker/less flexible sections of the container 380, that is, the second section 392 of the base portion 382 and the skirt portion 398, remain exposed when the container 380 is in a substantially collapsed condition. However, it is to be understood that one of the thicker/less flexible sections (i.e., section 392 or the skirt portion 398) may have an inner receiving space large enough to accommodate the sidewall of the other section, and therefore, the container 380 may further collapse into a position in which only one of the sections 392 and the skirt portion 398 are exposed. In this embodiment of the presently disclosed and claimed inventive concept(s), the sidewall 394 of the first section 390 may collapse inwardly into the section covered by the larger section, or the sidewall 394 of the first section 390 may collapse outwardly around the smaller section, thereby disposing the sidewall 394 of the first section 390 between the sidewalls 396 and 402 of the second section 392 and the skirt portion 398, respectively, substantially as shown in FIG. 46. In this manner, both the first and second sections 390 and 392 of the base portion are disposed in at least a portion of the inner receiving space 406 of the skirt portion 398. The upper end 384 and/or the lower end 386 of the base portion 382 may be visible when the container 380 is in the substantially collapsed condition shown in FIG. 46; alternatively, both the upper end 384 and the lower end 386 of the base portion 382 may be disposed in the inner receiving space 406 of the skirt portion 398 when the container 380 is in the substantially collapsed condition of FIG. 46, and therefore neither end is visible when the container 380 is collapsed.

It is to be understood that the container 380 illustrated in FIGS. 44-46 may further be provided with an upper portion which may be attached to the base portion 382 and/or the skirt portion 398 of the container 380, as described in detail herein, and therefore a container 380 comprising the base portion 382 and skirt portion 384 as well as an upper portion is also within the scope of the presently disclosed and claimed inventive concept(s).

One or more of the condition modifying elements of the container 380 (i.e., the sections of material that are thinner and/or more flexible than the other sections of material), may also function as a shape-sustaining member for maintaining the container 380 in the substantially collapsed and/or substantially erect condition. Optionally, the container 380 may be provided with another feature that functions as a shape-sustaining member. For example, the upper end 400 of the skirt portion 398 of the container 380 is provided with a rolled edge 408. Rolled edges are known in the art to be shape-sustaining elements, and therefore the rolled edge 408 of the container 380 may be utilized as a shape-sustaining member to maintain the container 380 in a substantially erect and/or a substantially collapsed condition. In addition, the rolled edge 408 may be utilized with any of the containers described herein or with any containers within the scope of the presently disclosed and claimed inventive concept(s) as a shape-sustaining member for maintaining a container of the presently disclosed and claimed inventive concept(s) is a substantially erect and/or substantially collapsed condition.

While the containers 330 and 380 of FIGS. 40-43 and 44-46, respectively, are illustrated as being divided horizontally into cylindrical sections, it is to be understood that the containers of the presently disclosed and claimed inventive concept(s) may be constructed in a similar manner to the containers 330 and 380, except that the containers are divided vertically into sections, or divided at any other desired angle into sections. For example but not by way of limitation, the containers of the presently disclosed and claimed inventive concept(s) may be divided into generally square, generally rectangular, generally oval, generally round, generally elliptical, generally triangular, generally hexagonal, or generally octagonal shapes, or any other polygonal shape, or any combination of such shapes.

Shown in FIGS. 47-48 is another embodiment of the presently disclosed and claimed inventive concept(s). FIG. 47 illustrates a collapsible and/or erectable shape-sustaining container 420 in a substantially erect condition. The container 420 has an upper end 422, a lower end 424, a sidewall 426, and an inner receiving space 428. The sidewall 426 has at least one condition modifying element, such as a hinge-type element 430, disposed on a portion thereof. The sidewall 426 of the container 420 may further comprise a locking element 432 for maintaining the container 420 in the substantially erect condition. When the locking element 432 is released, the sidewall 426 of the container 420 is separated into two connected sections 434 and 436, as depicted in FIG. 48, wherein the container 420 is in a substantially collapsed condition. Particularly, the condition modifying element 430 and the locking element 432 are oppositely disposed from one another, thereby providing sections 434 and 436 of substantially identical size. However, it is to be understood that the locking element 432 may be disposed at any location relative to the condition modifying element 430, as long as the container 420 is capable of functioning as described herein and is provided with substantially erect and substantially collapsed conditions. In addition, while the condition modifying element 430 and the locking element 432 are illustrated as being generally vertically disposed so that container 420 collapses in a vertical manner, it is to be understood that the condition modifying element 430 and the locking element 432 could also be disposed horizontally, such that the container separates into upper and lower connected portions. Further, the condition modifying element 430 and the locking element 432 may be disposed in any angular configuration, so long as the container 420 is capable of functioning as described herein and is provided with substantially erect and substantially collapsed conditions.

While the container 420 is illustrated as having one condition modifying element 430 that divides the container 420 into two sections 434 and 436, it is to be understood that the container 420 may be provided with two or more condition modifying elements 430, and the container 420 may comprise any desired number of sections. Thus, any container constructed similar to the container 420 and having two more condition modifying elements 430 and three or more sections that is capable of functioning in accordance with the presently disclosed and claimed inventive concept(s) is also within the scope of the presently disclosed and claimed inventive concept(s).

It is to be understood that the container 420 illustrated in FIGS. 47-48 may further be provided with a skirt portion and/or an upper portion, as described in detail herein, and therefore a container 420 comprising a skirt portion and/or an upper portion is also within the scope of the presently disclosed and claimed inventive concept(s).

The locking element 432 is described herein as functioning as a shape-sustaining member for maintaining the container 420 in a substantially erect condition. However, the condition modifying element 430 may also function as a shape-sustaining member for maintaining the container 420 in the substantially erect condition. In addition, the locking element 432 and/or the condition modifying element 430 may function as a shape-sustaining member to maintain the container 420 in the substantially collapsed condition, or another feature may be provided that functions in this manner. Optionally, the container 420 may not be provided with shape-sustaining member for maintaining the container 420 in the substantially collapsed condition.

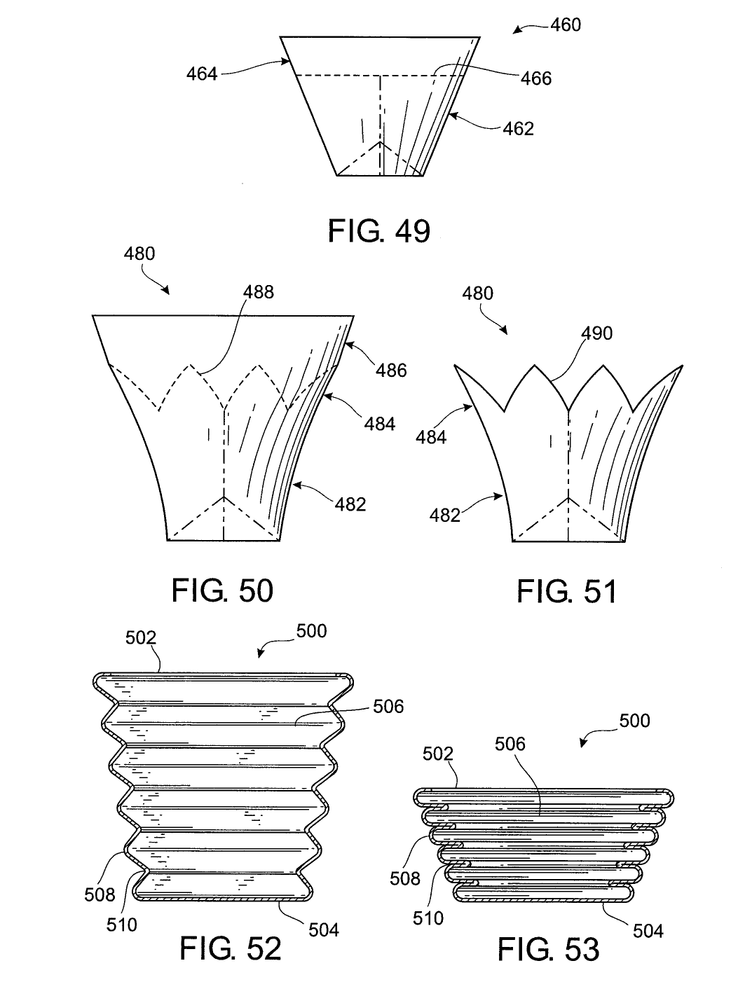

FIG. 49 depicts another collapsible and/or erectable container 460. The container 460 is similar in construction to and collapses in the same manner as the container 200 described in detail with reference to FIGS. 23-25, except that in addition to a base portion 462, the container 460 also comprises an upper portion 464 attached to the base portion 462. In a particular embodiment, the upper portion 464 is attached to an upper end 466 of the base portion 462. The upper portion 464 may be formed integrally with the base portion 462, or the upper portion 464 may be formed separately from the base portion 462 and attached to the base portion 462 after construction thereof. The upper portion 464 may be formed of the same or different material(s) than the base portion 462. In addition, the upper portion 464 may be detachable from the base portion 462, such as but not limited to, by perforations.

Any of the containers described herein above may be provided with an upper portion as described herein above in relation to container 460 of FIG. 49.

FIGS. 50-51 depict another collapsible and/or erectable container 480. The container 480 is similar in construction to and collapses in the same manner as the container 200 described in detail with reference to FIGS. 23-25, except that in addition to a base portion 482, the container 480 further comprises a skirt portion 484 attached to the base portion 482, and an upper portion 486. The upper portion 486 is illustrated in FIGS. 50-51 as being attached to the skirt portion 484; however, it is also to be understood that the upper portion 486 may be attached to the base portion 482, such that the skirt portion 484 is disposed inside the upper portion 486. The skirt portion 484 may be formed integrally with the base portion 482, or the skirt portion 484 may be formed separately from the base portion 482 and attached to the base portion 482 after construction thereof. The upper portion 486 may be formed integrally with the skirt portion 484 and/or the base portion 482, or the upper portion 486 may be formed separately from the skirt portion 484 and/or the base portion 482 and attached to the skirt portion 484 or the base portion 482 after construction thereof. The skirt portion 484 and the upper portion 486 may be formed of the same or different material(s) than the base portion 482.

The upper portion 486 may be detachable from the base portion 482 and skirt portion 484, such as along a detaching element 488, as shown in FIGS. 50-51. Detachment of the upper portion 486 provides the skirt portion 484 with an upper edge 490. The upper edge 490 of the skirt portion 484 may be provided with any configuration described herein or known in the art.

Any of the containers described hereinabove may be provided with a skirt portion and an upper portion as described hereinabove in relation to container 480 of FIGS. 50-51.

Shown in FIGS. 52-53 is another embodiment of the presently disclosed and claimed inventive concept(s). FIG. 52 illustrates a collapsible and/or erectable shape-sustaining container 500 in a substantially erect condition. The container 500 has an upper end 502, a lower end 504, and a sidewall 506. The sidewall 506 of the container 500 comprises a plurality of segments, such as a plurality of scalloped segments 508 as shown in FIG. 52, and a point 510 is disposed in between each set of two scalloped segments 508. In one embodiment, the points 510 may be thinner and/or more flexible than the remainder of the container 500.

Shown in FIG. 53 is the container 500 in a substantially collapsed condition. The points 510 allow the container 500 to compress so the area between the scalloped segments 508 is condensed in size, and the container 500 moves to a position in which the scalloped segments 508 are disposed substantially one on top of the other with substantially no space in between the scalloped segments 508. In one embodiment, the scalloped segments 508 may also compress to some extent, thereby reducing the height and/or volume of the container 500 in the substantially collapsed condition when compared with the substantially erect condition.

It is to be understood that the container 500 illustrated in FIGS. 52-53 may further be provided with an upper portion which may be attached to the container 500. One or more of the condition modifying elements of the container 500 (i.e., the points 510 and/or the scalloped segments 508), may also function as a shape-sustaining member for maintaining the container 500 in the substantially collapsed and/or substantially erect condition. Optionally, the container 500 may be provided with another feature that functions as a shape-sustaining member.

While the container 500 is illustrated as having scalloped segments 508 that are disposed generally horizontally across the sidewall 506 of the container 500, it is to be understood that a container having scalloped segments disposed generally vertically across the sidewall of the container or divided into scalloped segments at any other desired angle would also be within the scope of the presently disclosed and claimed inventive concept(s). In addition, the container 500 may have an open lower end 502, or the lower end 502 of the container 500 may be closed with a bottom formed therein. The addition of a bottom to the container 500 is fully within the skill of a person having ordinary skill in the art, and the bottom may be provided with one or more condition modifying elements and/or shape-sustaining members as described herein.

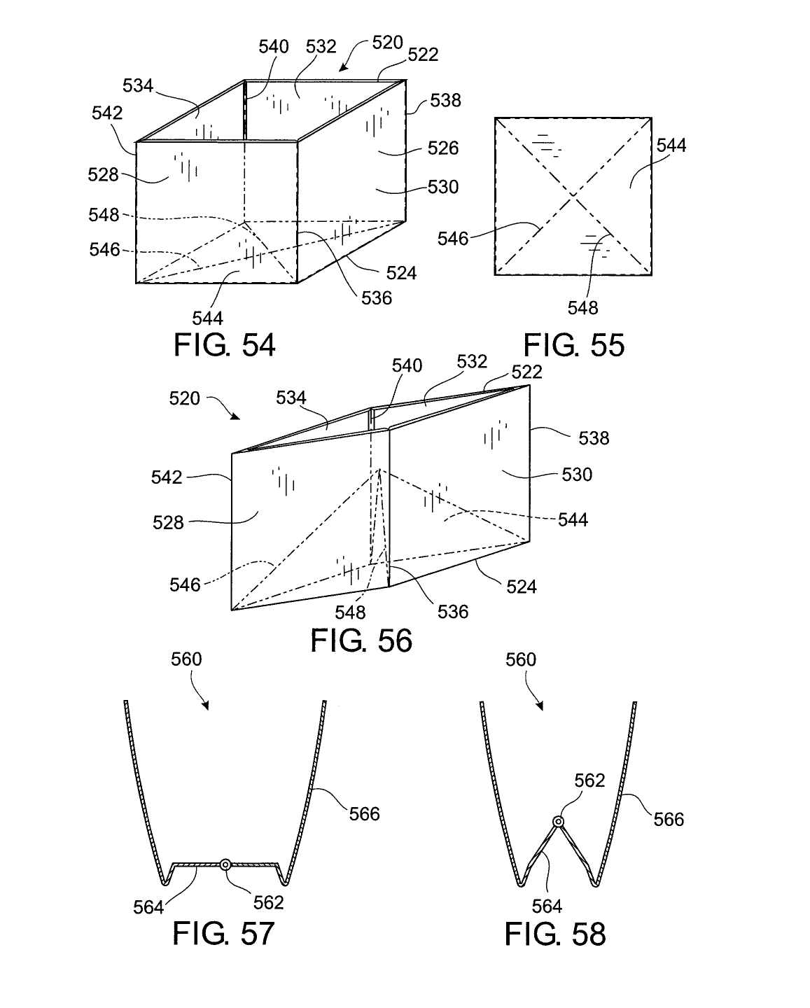

Shown in FIGS. 54-56 is another embodiment of the presently disclosed and claimed inventive concept(s). FIG. 54 depicts a collapsible and/or erectable shape-sustaining container 520 in a substantially erect condition. The container 520 has an upper end 522, a lower end 524, and a sidewall 526. The sidewall 526 of the container 520 comprises a first panel 528, a second panel 530, a third panel 532, and a fourth panel 534. The four panels 528, 530, 532 and 534 provide the sidewall 526 of the container 520 with a substantially square or rectangular shape. A joint 536 is formed between the first and second panels 528 and 530, a joint 538 is formed between the second and third panels 530 and 532, a joint 540 is formed between the third and fourth panels 532 and 534, and a joint 542 is formed between the fourth and first panels 523 and 528. The joints 536, 538, 540 and 542 are condition modifying elements, such as score lines, folds, hinges, areas of material that are thinner and/or more flexible than the remainder of the sidewall 526 of the container 520, and the like, such that the container 520 may be moved from a substantially erect condition, as shown in FIG. 54, to a substantially collapsed condition, as shown in FIG. 56. In the substantially collapsed condition, two of the joints 536, 538, 540 and 542 are disposed in closer proximity to one another than they were in the substantially erect condition. For example, as shown in FIG. 56, the joints 536 and 540 are disposed in closer proximity to one another than they were in the substantially erect condition. However, it is to be understood that the joints 538 and 542 may alternately be disposed in closer proximity to one another than they were in the substantially erect condition.

In addition, in a particular embodiment, the joints 536 and 540 (or optionally the joints 538 and 542) may be disposed substantially adjacent to one another. However, it is to be understood that the container 520 may be provided with several substantially collapsed conditions in accordance with the presently disclosed and claimed inventive concept(s), and therefore the substantially collapsed condition does not require that the container 520 be flattened such that the joints 536 and 540 (or the joints 538 and 542) are substantially adjacent to one another, but simply requires that the joints 536 and 540 (or the joints 538 and 542) are disposed in closer proximity to one another than they were in the substantially erect condition.

The container 520 is illustrated in FIGS. 54-56 as having a lower end 524 that is closed with a bottom 544. The bottom 544 is illustrated as having two condition modifying elements 546 and 548, such as score lines, formed therein. However, it is to be understood that the bottom 544 may be provided with only one condition modifying element formed therein or no condition modifying elements formed therein. Also, it is to be understood that one or more shape-sustaining members could be substituted for one or both of the condition modifying elements 546 and 548. In addition, one or both of the condition modifying elements 546 and 548 may also function as shape-sustaining members for the container 520.

While the condition modifying elements 546 and 548 are illustrated as being formed in a generally diagonal shape spanning the bottom 544 of the container 520, it is to be understood that the condition modifying elements 546 and 548 may assume any configuration described herein or known in the art. FIG. 56 illustrates how the condition modifying elements 546 and 548 aid in collapsing of the container 520.

As described herein, the collapsible and/or erectable containers of the presently disclosed and claimed inventive concept(s) may further be provided with one or more shape-sustaining members formed therein. FIGS. 57-60 illustrate two embodiments of shape-sustaining members that may be utilized with any of the collapsible and/or erectable containers of the presently disclosed and claimed inventive concept(s).

FIGS. 57 and 58 illustrate a collapsible and/or erectable shape-sustaining container 560 in substantially erect and substantially collapsed conditions, respectively. The container 560 is provided with a shape-sustaining member 562 formed in a bottom 564 thereof. The shape-sustaining member 562 is illustrated as being a hinge formed substantially in the center of the bottom 564 of the container 560. However, it is to be understood that any shape-sustaining member described herein or known in the art may be utilized as the shape-sustaining member 562, and the shape-sustaining member 562 may be disposed at any desired point on the bottom 564 of the container 560, such as but not limited to, a point in the bottom 564 that is generally off-center, so long as the shape-sustaining member is capable of maintaining the container 560 in the substantially erect and/or substantially collapsed condition and is capable of functioning in accordance with the presently disclosed and claimed inventive concept(s). In addition, while the shape-sustaining member 562 is depicted as being disposed in the bottom 564 of the container 560, it is to be understood that the shape-sustaining member 562 may be disposed at any desired position on the container 560, such as on a portion of a sidewall 566 of the container 560.

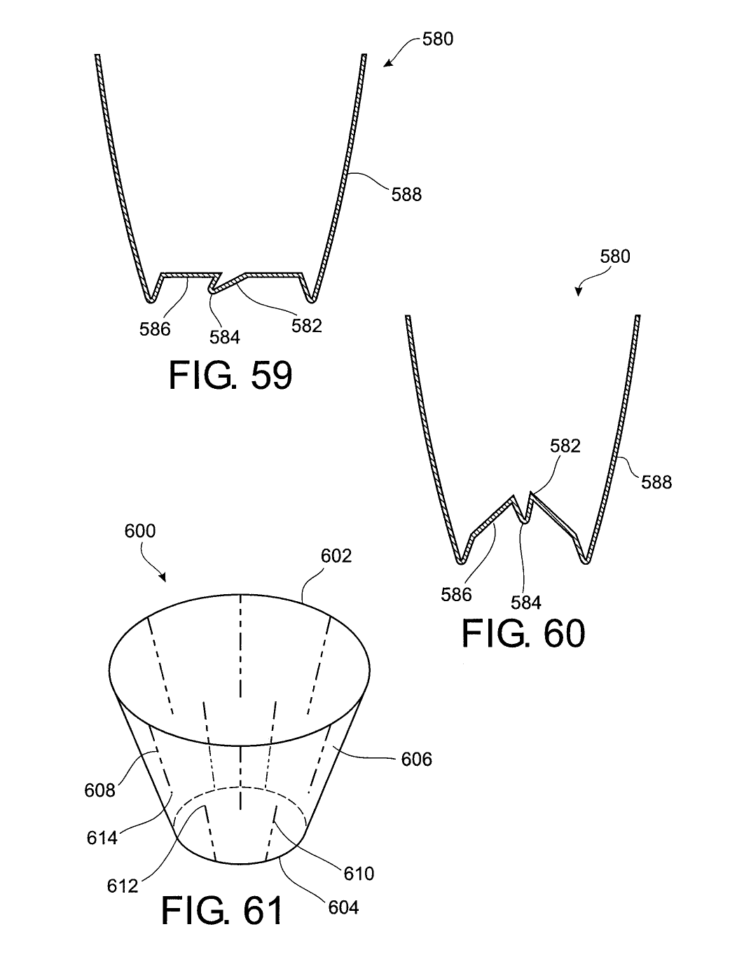

FIGS. 59 and 60 illustrate a collapsible and/or erectable shape-sustaining container 580 similar to the container 560 of FIGS. 57 and 58, except that a shape-sustaining member 582 is illustrated as being a hinge and further provided with a toggle member 584 for assisting in moving the container 580 from a substantially erect condition (as shown in FIG. 59) to a substantially collapsed condition (as shown in FIG. 60). As stated above, the shape-sustaining member 582 is not limited to being disposed in the bottom 586 of the container 580, but may alternatively be disposed in a sidewall 588 of the container 580.

The containers 560 and 580 of FIGS. 58-60 may be provided with any of the condition modifying elements described herein for facilitating collapsing and/or erecting the containers 560 and 580. In addition, the containers 560 and 580 may be provided with a skirt portion and/or an upper portion, as described herein.

Shown in FIG. 61 is another embodiment of the presently disclosed and claimed inventive concept(s). FIG. 61 depicts a collapsible and/or erectable shape-sustaining container 600 in a substantially erect condition. The container 600 has an upper end 602, a lower end 604, and a sidewall 606. The container 600 is provided with a first plurality of score lines 608, which extend from the upper end 602 generally downwardly, and a second plurality of score lines 610, which extend from the lower end 604 generally upwardly. The first plurality of score lines 608 are offset from and do not intersect with the second plurality of score lines 610.

The offsetting of the first and second plurality of score lines 608 and 610 provides resistance to collapsing, and therefore functions as a shape-sustaining member. However, it is to be understood that the use of offset score lines is not limited to score lines, and any other element capable of functioning in this manner may be utilized as shown in FIG. 61. In addition, while the first and second plurality of score lines 608 and 610 are depicted as extending generally vertically across the container 600, it is to be understood that the first and second plurality of score lines 608 and 610 may extend at any angle along the sidewall 606 of the container 600, such as but not limited to, horizontally or diagonally, so long as the first and second plurality of score lines 608 and 610 are offset from one another and function in accordance with the presently disclosed and claimed inventive concept(s).

The second plurality of score lines 610 may extend upwardly into a portion of the sidewall 606 and have an upper end 612 that extends above and beyond a lower end 614 of the first plurality of score lines 608. Optionally, the upper end 612 of the second plurality of score lines 610 may be disposed substantially adjacent the lower end 614 of the first plurality of score lines 608. In another alternative, the upper end 612 of the second plurality of score lines 610 may be disposed below the lower end 614 of the first plurality of score lines 608; therefore, a horizontal portion of the sidewall 606 of the container 600 may be free of the score lines 608 and 610.

Any of the collapsible and/or erectable containers described herein may be erected and/or collapsed manually, that is, the containers require energy from an exogenous source to fully erect and/or collapse the container. Optionally, any of the collapsible and/or erectable containers described herein may be self-erecting and/or self-collapsing. In addition, while some of the containers of the presently disclosed and claimed inventive concept(s) have been described herein as having bottoms formed therein, any of the containers described herein or encompassed by the scope of the presently disclosed and claimed inventive concept(s) may be provided with a bottom formed therein, and the bottom may have any desired configuration. In addition, the bottom may or may not be provided with one or more condition modifying elements and/or shape-sustaining or locking members formed therein. When provided with one or more condition modifying elements and/or shape-sustaining members formed therein, the condition modifying element(s) and/or shape-sustaining member(s) may be provided with any configuration described herein or any configuration known in the art.

From the above description it is clear that the presently disclosed and claimed inventive concept(s) is well adapted to carry out the objects and to attain the advantages mentioned herein as well as those inherent in the presently disclosed and claimed inventive concept(s). While presently particular embodiments of the presently disclosed and claimed inventive concept(s) have been described for purposes of this disclosure, it will be understood that numerous changes may be made which will readily suggest themselves to those skilled in the art and which are accomplished within the spirit of the presently disclosed and claimed inventive concept(s) disclosed and as defined in the appended claims.

What is claimed is:

1. A method of providing a decorative cover for at least one item, the method comprising the steps of:
moving a flower pot and/or plant cover from a substantially collapsed condition to a substantially erect condition, the flower pot and/or plant cover having a base portion shaped to define a receiving space which is sized to receive at least one of a flower pot, a floral grouping, a plant, a propagule, growing medium, and a floral holding material, the base portion having an upper end, a lower end, and a sidewall, at least a portion of at least one of the sidewall and the lower end having at least one condition modifying element to facilitate erecting the base portion from the substantially collapsed condition to the substantially erect condition, wherein the at least one condition modifying element is selected from the group consisting of score lines, hinges, concentric sections, interlocking concentric sections, pivotally interlocking sections, sections of material which are thinner than the remainder of the base portion, sections of material that are more flexible than the remainder of the base portion, pleats, folds, perforations, creases, voids, partially or wholly cut through areas, removed portions of material, a V-shaped or U-shaped member, excess material, flexible material, stretchable material, and combinations thereof, wherein the flower pot and/or plant cover is moved from the substantially collapsed condition to the substantially erect condition by actuation of the at least one condition modifying element, and wherein in the substantially erect condition, the upper end of the base portion is at least partially open, and wherein at least one of:
(a) the flower pot and/or plant cover is absent a single curved internal gusset in the substantially collapsed condition; and
(b) the flower pot and/or plant cover is provided with excess material extending outwardly from the base portion in the substantially collapsed condition;
disposing at least one item in the receiving space of the flower pot and/or plant cover, wherein the at least one item is selected from the group consisting of a flower pot, a floral grouping, a plant, a propagule, growing medium, and a floral holding material, and combinations thereof.

2. The method of claim 1, wherein the flower pot and/or plant cover is shape-sustaining.

3. The method of claim 1, wherein the flower pot and/or plant cover further comprises an endogenously formed shape-sustaining member for maintaining the base in the substantially erect condition.

4. The method of claim 3, wherein the endogenously formed shape-sustaining member of the flower pot and/or plant cover also maintains the flower pot and/or plant cover in the substantially collapsed condition.

5. The method of claim 1, wherein the base portion of the flower pot and/or plant cover is free of overlapping folds.

6. The method of claim 1, wherein the flower pot and/or plant cover is provided with a substantially closed bottom.

7. The method of claim 6, wherein the bottom of the flower pot and/or plant cover has at least one drain opening formed therein.

8. The method of claim 6, wherein the bottom of the flower pot and/or plant cover is formed integrally with the base portion.

9. The method of claim 6, wherein at least a portion of at least one of the base portion and the bottom of the flower pot and/or plant cover has at least one additional condition modifying element to facilitate erecting the bottom from a substantially collapsed condition to a substantially erect condition, and wherein the flower pot and/or plant cover is moved from the substantially collapsed condition to the substantially erect condition by actuation of the at least two condition modifying elements.

10. The method of claim 1, wherein the base portion of the flower pot and/or plant cover is capable of substantially retaining liquid in the receiving space thereof.

11. The method of claim 1, wherein at least a portion of the flower pot and/or plant cover is provided with at least one of a printed pattern thereon, an embossed pattern thereon, a three-dimensional pattern thereon, a holographic image thereon, a printed pattern, a substantially matte finish thereon, an iridescent finish thereon, a textured finish thereon, and combinations thereof.

12. The method of claim 1, wherein the base portion of the flower pot and/or plant cover is provided with at least one of a linear upper edge, a non-linear upper edge, and a simulated contoured upper edge.

13. The method of claim 1, wherein the flower pot and/or plant cover further comprises a skirt portion positioned about the sidewall of the base portion and extending from the base portion.

14. The method of claim 13, wherein the skirt portion extends angularly from the base portion.

15. The method of claim 13, wherein the sidewall of the base portion includes an inner surface and an outer surface, and wherein the skirt portion is connected to at least one of the outer and inner surfaces of the sidewall of the base portion.

16. The method of claim 19, wherein the base portion and the skirt portion are integrally formed.

17. The method of claim 13, wherein the flower pot and/or plant cover further comprises a removable upper portion attached to at least a portion of one of the base and skirt portions thereof, and wherein the method further comprises the step of removing the upper portion of the flower pot and/or plant cover.

18. The method of claim 1, wherein the flower pot and/or plant cover is constructed of a material selected from the group consisting of natural polymers, synthetic polymers, plastic, paper, cardboard, cloth, metallized film, foil, metal, clay, feathers, peat moss, wood, and combinations, aggregates and laminations thereof.

19. The method of claim 1, wherein the method further comprising the step of securing the flower pot and/or plant cover about the at least one item disposed therein with at least one of a banding element and a bonding material.

20. The method of claim 1, wherein the flower pot and/or plant cover is produced by at least one of a thermoforming process, an injection-molding process, a blow-molding process, a casting process, a drawing process, a rolling process, and a stamping process.
